(19) United States
(12) Patent Application Publication
(10) Pub. No.: US 2026/0120243 A1
(43) Pub. Date: Apr. 30, 2026

(54) IMAGE DENOISING METHOD AND APPARATUS, COMPUTER DEVICE, AND STORAGE MEDIUM

(71) Applicant: Tencent Technology (Shenzhen) Company Limited, Shenzhen (CN)

(72) Inventor: Zicong He, Shenzhen (CN)

(21) Appl. No.: 19/018,664

(22) Filed: Jan. 13, 2025

Related U.S. Application Data
(63) Continuation of application No. PCT/CN2023/125970, filed on Oct. 23, 2023.

(30) Foreign Application Priority Data
Jan. 9, 2023 (CN) 202310024394.3

(51) Int. Cl. G06T 5/50; G06T 5/70; G06T 7/73

(52) U.S. Cl. CPC G06T 5/50; G06T 5/70; G06T 7/73; G06T 2207/20221

(57) ABSTRACT

This application relates to an image denoising method and apparatus, a computer device, and a storage medium. Techniques described herein denoise an image by acquiring a current diffuse reflection image and a current specular reflection image, acquiring a historical diffuse reflection image, and denoising the current diffuse reflection image using the historical diffuse reflection image, to obtain a target diffuse reflection image, acquiring a historical specular reflection image, and denoising the current specular reflection image using the historical specular reflection image, to obtain a target specular reflection image, and fusing the target diffuse reflection image and the target specular reflection image, to obtain a target image.

### RELATED APPLICATION

This application is a continuation application of PCT Application PCT/CN2023/125970, filed Oct. 23, 2023, which claims priority to Chinese Patent Application No. 202310024394.3, entitled “IMAGE DENOISING METHOD AND APPARATUS, COMPUTER DEVICE, AND STORAGE MEDIUM” filed on Jan. 9, 2023, each of which is incorporated herein by reference in its entirety.

### FIELD

This application relates to the field of image processing technologies, and in particular, to an image denoising method and apparatus, a computer device, and a storage medium.

### BACKGROUND

In the field of real-time rendering, global illumination rendering is usually used. Direct illumination and indirect illumination usually exist in a rendered image. The direct illumination may be generated by using a raster technology, and usually has small noise, and it is unnecessary to perform much denoising; while the indirect illumination is generally generated by a global illumination algorithm with a low sampling count, and usually has large noise. Therefore, a very important stage is to perform real-time denoising on an image rendered in real time.

In a conventional technology, a temporal filtering method is usually configured for performing real-time denoising on a rendered image. However, the conventional temporal filtering method usually has a problem of transition blur, resulting in a poor effect of real-time denoising, and it is likely that a result obtained after denoising cannot be used. As a result, although computer resources configured for supporting denoising are occupied, a good result is not achieved. Consequently, the computer resources configured for supporting denoising are wasted.

### SUMMARY

According to various embodiments provided in this application, an image denoising method and apparatus, a computer device, a computer-readable storage medium, and a computer program product are provided.

According to an aspect, this application provides an image denoising method, performed by a computer device, the method including: acquiring a current diffuse reflection image and a current specular reflection image, the current diffuse reflection image being an image obtained by performing illumination rendering on a scene region observed at a current moment by using diffuse reflection illumination, and the current specular reflection image being an image obtained by performing illumination rendering on the scene region observed at the current moment by using specular reflection illumination; acquiring a historical diffuse reflection image, the historical diffuse reflection image being an image obtained by performing illumination rendering on a scene region observed at a historical moment by using diffuse reflection illumination; denoising the current diffuse reflection image by using the historical diffuse reflection image, to obtain a target diffuse reflection image; acquiring a historical specular reflection image, the historical specular reflection image being an image obtained by performing illumination rendering on the scene region observed at the historical moment by using specular reflection illumination; denoising the current specular reflection image by using the historical specular reflection image, to obtain a target specular reflection image; and fusing the target diffuse reflection image and the target specular reflection image, to obtain a target image.

According to another aspect, this application further provides an image denoising apparatus. The apparatus includes: an image determining module, configured to acquire a current diffuse reflection image and a current specular reflection image, the current diffuse reflection image being an image obtained by performing illumination rendering on a scene region observed at a current moment by using diffuse reflection illumination, and the current specular reflection image being an image obtained by performing illumination rendering on the scene region observed at the current moment by using specular reflection illumination; the image determining module being further configured to acquire a historical diffuse reflection image, the historical diffuse reflection image being an image obtained by performing illumination rendering on a scene region observed at a historical moment by using diffuse reflection illumination; a diffuse reflection denoising module, configured to denoise the current diffuse reflection image by using the historical diffuse reflection image, to obtain a target diffuse reflection image; the image determining module being further configured to acquire a historical specular reflection image, the historical specular reflection image being an image obtained by performing illumination rendering on the scene region observed at the historical moment by using specular reflection illumination; a specular reflection denoising module, configured to denoise the current specular reflection image by using the historical specular reflection image, to obtain a target specular reflection image; and an image fusion module, configured to perform image fusion on the target diffuse reflection image and the target specular reflection image, to obtain a target image.

According to another aspect, this application further provides a computer device. The computer device includes a memory and one or more processors, the memory has computer-readable instructions stored therein, and the computer-readable instructions, when executed by the processor, cause the one or more processors to perform the foregoing image denoising method.

According to another aspect, this application further provides one or more non-volatile readable storage media. The computer-readable storage medium has computer-readable instructions stored therein, and the computer-readable instructions, when executed by one or more processors, cause the one or more processors to implement the foregoing image denoising method.

According to another aspect, this application further provides a computer program product. The computer program product includes computer-readable instructions, and the computer-readable instructions, when executed by a processor, implement the foregoing image denoising method.

Details of one or more embodiments of this application are provided in the accompany drawings and descriptions below. Other features, objectives, and advantages of this application will become apparent from the specification, the accompanying drawings, and the claims.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other accompanying drawings from these accompanying drawings without creative efforts.

FIG. 1 is a diagram of an application environment of an image denoising method according to some embodiments.

FIG. 2 is a schematic flowchart of an image denoising method according to some embodiments.

FIG. 3 is a schematic diagram of obtaining a target image according to some embodiments.

FIG. 4 is a schematic diagram of determining a first reference pixel according to some embodiments.

FIG. 5 is a schematic diagram of ghosting according to some embodiments.

FIG. 6 is a schematic diagram of determining a second reference pixel according to some embodiments.

FIG. 7 is a schematic flowchart of an image denoising method according to some other embodiments.

FIG. 8 is a diagram of a denoising effect according to some embodiments.

FIG. 9 is a diagram of a denoising effect according to some other embodiments.

FIG. 10 is a diagram of an interface of implementing rendering according to some embodiments.

FIG. 11 is a structural block diagram of an image denoising apparatus according to some embodiments.

FIG. 12 is a diagram of an internal structure of a computer device according to some embodiments.

FIG. 13 is a diagram of an internal structure of a computer device according to some other embodiments.

### DETAILED DESCRIPTION

The technical solutions in the embodiments of this application are clearly described in the following with reference to the accompanying drawings. The embodiments described are merely a part rather than all of the embodiments of the present application. All other embodiments obtained by persons of ordinary skill in the art based on the embodiments of this application without creative efforts shall fall within the protection scope of this application. The use of the word “embodiment” should not be construed as limiting, but rather as interchangeable with the word “aspect” for use in describing the innovations herein.

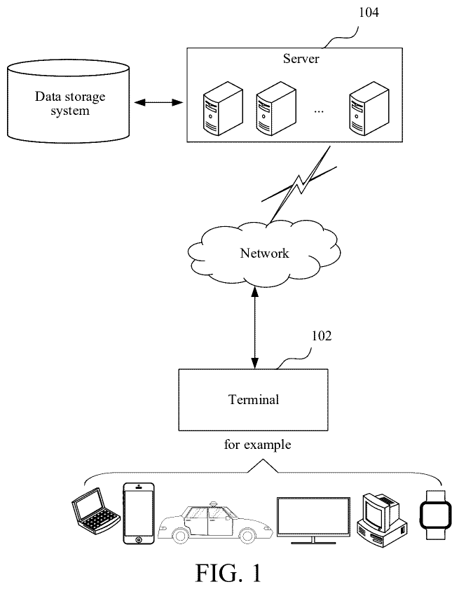

An image denoising method provided in an embodiment of this application may be applied to an application environment shown in FIG. 1. A terminal 102 communicates with a server 104 by using a network. A data storage system may store data that the server 104 needs to process. The data storage system may be integrated on the server 104, or may be placed on a cloud or another server.

Specifically, an application may be installed on the terminal 102. The application is an application that provides a real-time rendering function. For example, the application is a game application. After the terminal 102 starts the application, real-time rendering is performed, and an image rendered in real time is displayed in real time. In a real-time rendering process, the terminal 102 may acquire a current diffuse reflection image and a current specular reflection image, and acquire a historical diffuse reflection image and a historical specular reflection image; denoise the current diffuse reflection image by using the historical diffuse reflection image to obtain a target diffuse reflection image; denoise the current specular reflection image by using the historical specular reflection image to obtain a target specular reflection image; and perform image fusion on the target diffuse reflection image and the target specular reflection image to obtain a target image. The current diffuse reflection image is an image obtained by performing illumination rendering on a scene region observed at a current moment by using diffuse reflection illumination, the current specular reflection image is an image obtained by performing illumination rendering on the scene region observed at the current moment by using specular reflection illumination, the historical diffuse reflection image is an image obtained by performing illumination rendering on a scene region observed at a historical moment by using diffuse reflection illumination, and the historical specular reflection image is an image obtained by performing illumination rendering on the scene region observed at the historical moment by using specular reflection illumination. The terminal 102 may transmit the target image to the server 104, and the server 104 may store the target image or transmit the target image to another device. The terminal 102 may further display the target image.

The terminal 102 may be, but not limited to, a desktop computer, a notebook computer, a smartphone, a tablet computer, an Internet of Things device, and a portable wearable device. The Internet of Things device may be a smart speaker, a smart television, a smart air conditioner, a smart in-vehicle device, or the like. The portable wearable device may be a smartwatch, a smart band, a head mounted device, or the like. The server 104 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal 102 and the server 104 may be directly or indirectly connected in a wired or wireless communication manner. This is not limited in this application.

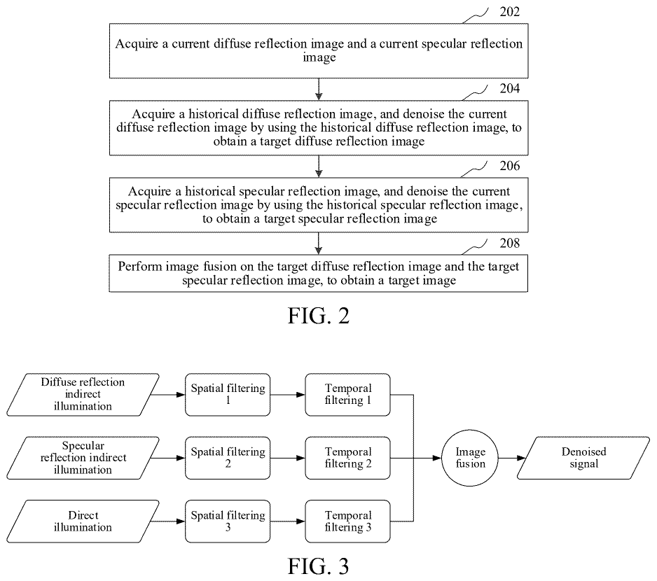

In some embodiments, as shown in FIG. 2, an image denoising method is provided. The method may be performed by a terminal or a server, or may be jointly performed by a terminal and a server. An example in which the method is applied to the terminal 102 in FIG. 1 is used for description, and the method includes the following operations:

Operation 202. Acquire a current diffuse reflection image and a current specular reflection image.

The current diffuse reflection image is an image obtained by performing illumination rendering on a scene region observed at a current moment by using diffuse reflection illumination, and the current specular reflection image is an image obtained by performing illumination rendering on the scene region observed at the current moment by using specular reflection illumination. The scene region refers to a region in a virtual scene. The virtual scene is a virtual scene displayed (or provided) by an application program when run on the terminal. The virtual scene may be a simulated environment of a real world, or may be a semi-simulated semi-fictional virtual scene, or may be an entirely fictional virtual scene. The virtual scene may be any one of a two-dimensional virtual scene, a 2.5-dimensional virtual scene, and a three-dimensional virtual scene. The virtual scene may be, for example, a game scene, a Virtual Reality (VR) scene, or an animation scene.

The current diffuse reflection image may be an image obtained directly or indirectly by performing illumination rendering on a scene region observed at a current moment by using diffuse reflection illumination. The current specular reflection image may be an image obtained directly or indirectly by performing illumination rendering on the scene region observed at the current moment by using specular reflection illumination. Both diffuse reflection illumination and specular reflection illumination are indirect illumination. The diffuse reflection illumination may also be referred to as diffuse reflection indirect illumination, and the specular reflection illumination may also be referred to as specular reflection indirect illumination. In diffuse reflection illumination, photons collide with a rough surface and then are randomly scattered in all directions. In specular reflection illumination, when hitting a strongly reflective surface such as a mirror, photons bounce back in a predictable direction. In indirect illumination, a light ray bounces back from a surface of an object one or more times, and the plurality of times means at least twice.

The scene region may include at least one virtual object. Each virtual object has a shape and a volume in the virtual scene, and occupies some space in the virtual scene. The virtual object may be an inanimate object. The inanimate object includes, but is not limited to, buildings, vegetation, sky, roads, mountain stones, or water bodies. The virtual object may alternatively be an animate object. The animate object includes, but is not limited to, a virtual animal or a digital person. The digital person is a computer-generated character intended to duplicate human behaviors and personality characteristics. In other words, the digital person is a realistic three-dimensional (3D) human model. The digital person can appear anywhere within the scope of realism, from fantasy characters of children (behaving humans) to super-realistic digital actors, and these characters are hardly different from real humans. The progress of digital persons is mainly driven by talent and technology in the world of fusing animation, visual effects, and video games. The digital person may include a virtual person and a virtual digital person. An identity of the virtual person is fictional and does not exist in the real world. For example, the virtual person includes a virtual anchor, and the virtual digital person emphasizes a virtual identity and digital production characteristics. The virtual digital person may have the following three features: owning an appearance of a person, and having specific character characteristics such as appearance, gender, and personality; owning behavior of a person, and having the ability to perform expression by using language, facial expressions, and body actions; and owning an idea of a person, and having the ability to recognize an external environment and communicate with and interact with a person. The current diffuse reflection image and the current specular reflection image that are rendered may include the virtual object in the scene region.

Specifically, the current diffuse reflection image may be generated by the terminal. For example, the current diffuse reflection image may be an image obtained directly by performing illumination rendering on a scene region observed at a current moment by using diffuse reflection illumination. An image obtained directly by performing illumination rendering on a scene region observed at a current moment by using diffuse reflection illumination may be referred to as a diffuse reflection image corresponding to the current moment. The terminal may use the diffuse reflection image corresponding to the current moment as the current diffuse reflection image. Certainly, the current diffuse reflection image may alternatively be an image obtained indirectly by performing illumination rendering on a scene region observed at a current moment by using diffuse reflection illumination. For example, the terminal may spatially filter, that is, spatially denoise the diffuse reflection image corresponding to the current moment, to obtain a spatially denoised diffuse reflection image corresponding to the current moment. The terminal may determine the spatially denoised diffuse reflection image corresponding to the current moment as the current diffuse reflection image. The diffuse reflection image corresponding to the current moment may be generated by the terminal. For example, the terminal may perform illumination rendering on a scene region observed at a current moment by using diffuse reflection illumination, and the rendered image is a diffuse reflection image corresponding to the current moment. The diffuse reflection image corresponding to the current moment may alternatively be acquired by the terminal from the server. Certainly, the current diffuse reflection image may alternatively be acquired by the terminal from the server.

In some embodiments, the current specular reflection image may be generated by the terminal. For example, the current specular reflection image may be an image obtained directly by performing illumination rendering on the scene region observed at the current moment by using specular reflection illumination. An image obtained directly by performing illumination rendering on a scene region observed at a current moment by using specular reflection illumination may be referred to as a specular reflection image corresponding to the current moment. The terminal may use the specular reflection image corresponding to the current moment as the current specular reflection image. Certainly, the current specular reflection image may be an image obtained indirectly by performing illumination rendering on the scene region observed at the current moment by using specular reflection illumination. Specifically, the terminal may spatially filter, that is, spatially denoise the specular reflection image corresponding to the current moment, to obtain a spatially denoised specular reflection image corresponding to the current moment. The terminal may determine the spatially denoised specular reflection image corresponding to the current moment as the current specular reflection image. The specular reflection image corresponding to the current moment may alternatively be acquired by the terminal from the server. The specular reflection image corresponding to the current moment may be generated by the terminal. For example, the terminal may perform illumination rendering on a scene region observed at a current moment by using specular reflection illumination, and the rendered image is a specular reflection image corresponding to the current moment. The specular reflection image corresponding to the current moment may alternatively be acquired by the terminal from the server. Certainly, the current specular reflection image may alternatively be acquired by the terminal from the server.

The diffuse reflection image corresponding to the current moment and the specular reflection image corresponding to the current moment may be simultaneously rendered, or may be sequentially rendered. For example, the diffuse reflection image corresponding to the current moment is rendered first, and then the specular reflection image corresponding to the current moment is rendered, or the specular reflection image corresponding to the current moment is rendered first, and then the diffuse reflection image corresponding to the current moment is rendered. A rendering sequence is not limited herein.

Operation 204. Acquire a historical diffuse reflection image, and denoise the current diffuse reflection image by using the historical diffuse reflection image, to obtain a target diffuse reflection image.

The historical moment is a moment before the current moment, and a time interval between the historical moment and the current moment may be a time interval between two adjacent frames of images in a real-time rendering process. Certainly, the time interval between the historical moment and the current moment may alternatively be greater than a frame interval, for example, may be an integer multiple of the frame interval. The frame interval refers to the time interval between two adjacent frames of images. The virtual scene has a virtual camera, the observed scene region refers to a scene region observed by the virtual camera, and at least one of a position or an observation direction of the virtual camera may change. Therefore, the position and the observation direction of the virtual camera at the current moment may be the same as or different from the position and the observation direction at the historical moment. Therefore, the scene region observed at the historical moment may be the same as or different from the scene region observed at the current moment.

The historical diffuse reflection image is an image obtained by performing illumination rendering on a scene region observed at a historical moment by using diffuse reflection illumination. The historical diffuse reflection image is an image obtained directly or indirectly by performing illumination rendering on a scene region observed at a historical moment by using diffuse reflection illumination. An image obtained directly by performing illumination rendering on a scene region observed at a historical moment by using diffuse reflection illumination may be denoted as a diffuse reflection image corresponding to the historical moment. The process of determining the historical diffuse reflection image is consistent with the method of determining the current diffuse reflection image. When the current diffuse reflection image is the diffuse reflection image corresponding to the current moment, the historical diffuse reflection image is the diffuse reflection image corresponding to the historical moment. When the current diffuse reflection image is the spatially denoised diffuse reflection image corresponding to the current moment, the historical diffuse reflection image is the spatially denoised diffuse reflection image corresponding to the historical moment. The spatially denoised diffuse reflection image corresponding to the historical moment is an image obtained by spatially filtering, that is, spatially denoising the diffuse reflection image corresponding to the historical moment.

The denoising may also be referred to as filtering, and the filtering includes at least one of spatial filtering or temporal filtering. That is, denoising may be implemented through at least one of spatial filtering or temporal filtering. Spatial filtering refers to filtering that directly modifies or suppresses image data, and reduces noise on an image space geometric variable domain. Temporal filtering refers to filtering that reduces noise by performing sampling in a time domain to increase the quantity of samples. The denoising the current diffuse reflection image by using the historical diffuse reflection image belongs to a method for denoising by temporal filtering. Temporal filtering is a technical means whose concept is not specific, and denoising the current diffuse reflection image by using the historical diffuse reflection image proposed in this application belongs to a new method for implementing temporal filtering. The spatial filtering in this application may be any method that can implement spatial filtering, which is not limited herein.

Specifically, for each first current pixel, the terminal may determine a first reference pixel corresponding to the first current pixel from the historical diffuse reflection image, and fuse a pixel value of the first current pixel and a pixel value of the corresponding first reference pixel, to obtain a fused pixel value corresponding to the first current pixel. The fused pixel value is a result obtained after denoising. The reason why denoising can be implemented by fusing pixel values is as follows: In continuously played images, if a difference between pixel values on the same object is relatively large, relatively large noise is reflected, and a flicker problem is presented. Therefore, pixel value fusion is performed, so that pixel values on the same object in played images can be kept stable, thereby achieving a denoising effect, and alleviating the flicker problem. The first reference pixel is determined based on world coordinates of the first current pixel. The world coordinates are coordinates obtained after the coordinates of the first current pixel in the screen space are mapped to the world space. The world space is a three-dimensional space in which the virtual scene is located. A size of the world space may be customized. For example, the world space is three-dimensional space with a length of 100 meters, a width of 100 meters, and a height of 100 meters. The world coordinates refer to coordinates in the world space, and the world coordinates are three-dimensional coordinates. A position in the world space is represented by using world coordinates. The screen space is a two-dimensional space in which a screen is located. A size of the screen space is a size of the screen in pixels.

In some embodiments, the terminal may determine world coordinates of a world space point corresponding to the first current pixel at the historical moment, to obtain first historical world coordinates, where the world space point is a point in the world space. For example, all points on each virtual object in the world space are world space points. The terminal may determine, based on a pixel corresponding to the first historical world coordinates in the historical diffuse reflection image, the first reference pixel corresponding to the first current pixel. The first current pixel is a pixel in the current diffuse reflection image.

Operation 206. Acquire a historical specular reflection image, and denoise the current specular reflection image by using the historical specular reflection image, to obtain a target specular reflection image.

In a real-time rendering process, the terminal performs global illumination rendering and denoising on a scene region observed at a current moment, to obtain a current frame of image. The global illumination includes direct illumination and indirect illumination, and the indirect illumination includes diffuse reflection illumination and specular reflection illumination. In direct illumination, a light ray directly illuminates a surface of an object, and no photon bounces back. The terminal may perform illumination rendering on a scene region observed at a current moment by using each of direct illumination, diffuse reflection illumination, and specular reflection illumination, denoise images obtained through illumination rendering by using related images of a historical frame of image, and then fuse the denoised images to obtain a current frame of image. The historical frame of image may be a previous frame of image of the current frame of image or an image separated from the current frame of image by at least two frames. Both the historical diffuse reflection image and the historical specular reflection image are related images of the historical frame of image. The historical frame of image is an image obtained by performing image fusion on an image obtained by temporally denoising the historical specular reflection image and an image obtained by temporally denoising the historical diffuse reflection image.

The historical specular reflection image is an image obtained by performing illumination rendering on the scene region observed at the historical moment by using specular reflection illumination. The denoising the current specular reflection image by using the historical specular reflection image belongs to a method for denoising by temporal filtering. Temporal filtering is a technical means whose concept is not specific, and denoising the current specular reflection image by using the historical specular reflection image proposed in this application belongs to a new method for implementing temporal filtering.

The historical specular reflection image is an image obtained directly or indirectly by performing illumination rendering on a scene region observed at a historical moment by using specular reflection illumination. An image obtained directly by performing illumination rendering on a scene region observed at a historical moment by using specular reflection illumination may be denoted as a specular reflection image corresponding to the historical moment. The process of determining the historical specular reflection image is consistent with the method of determining the current specular reflection image. When the current specular reflection image is the specular reflection image corresponding to the current moment, the historical specular reflection image is the specular reflection image corresponding to the historical moment. When the current specular reflection image is the spatially denoised specular reflection image corresponding to the current moment, the historical specular reflection image is the spatially denoised specular reflection image corresponding to the historical moment. The spatially denoised specular reflection image corresponding to the historical moment is an image obtained by spatially filtering, that is, spatially denoising the specular reflection image corresponding to the historical moment.

Specifically, for each second current pixel, the terminal may determine a position of a virtual image point corresponding to the second current pixel to obtain a virtual image point position. The virtual image point refers to a point on a virtual image in a specular reflection phenomenon. Any two light rays emitted by any point on the virtual object in the virtual scene are reflected on a plane on which specular reflection occurs to obtain two reflected light rays, and an intersection point between reverse extension lines of the two reflected light rays is a virtual image point corresponding to the point on the virtual object. A set of virtual image points respectively corresponding to points on an object is a virtual image of the object. For a virtual object in the world space, if one of two light rays emitted by a point on the virtual object is specularly reflected at the world space point corresponding to the second current pixel, and a reflected light ray of the light ray is observed at the current moment, two reflected light rays obtained after the two light rays are respectively specularly reflected are determined, and an intersection point between reverse extension lines of the two reflected light rays is the virtual image point corresponding to the second current pixel. The terminal may determine a connecting line between the observation position at the historical moment and the virtual image point position to obtain a target connecting line, determine a position at which the target connecting line intersects with a normal plane of the second current pixel to obtain a target intersection point position, and determine a pixel corresponding to the target intersection point position in the historical specular reflection image as a second reference pixel of the second current pixel. The second current pixel is a pixel in the current specular reflection image.

In some embodiments, for each second current pixel, the terminal may determine world coordinates of a world space point corresponding to the second current pixel at a historical moment, to obtain third historical world coordinates, and determine a third reference pixel corresponding to the second current pixel based on a pixel corresponding to the third historical world coordinates in the historical specular reflection image. For example, the terminal may map the third historical world coordinates from the world space to the screen space to obtain screen space coordinates corresponding to the third historical world coordinates, and determine a pixel at the screen space coordinates from the historical specular reflection image to obtain a second historical pixel. The terminal may determine the second historical pixel as a third reference pixel corresponding to the second current pixel.

In some embodiments, for the second current pixels, the terminal may separately denoise the second current pixels by using at least one of the corresponding second reference pixel or the corresponding third reference pixel, to obtain the target specular reflection image. Specifically, for each second current pixel, the terminal may perform statistical calculation on the pixel value of the second current pixel and at least one of the pixel value of the second reference pixel or the pixel value of the third reference pixel, to obtain a fused pixel value of the second current pixel. For example, the terminal may perform statistical calculation on the pixel value of the second current pixel and the pixel value of the corresponding second reference pixel, and use a calculation result as the fused pixel value of the second current pixel. Alternatively, the terminal may perform statistical calculation on the pixel value of the second current pixel and the pixel value of the corresponding third reference pixel, and use a calculation result as the fused pixel value of the second current pixel. Alternatively, the terminal may perform statistical calculation on the pixel values respectively corresponding to the second current pixel, the second reference pixel, and the third reference pixel, and use a calculation result as the fused pixel value of the second current pixel. The terminal may replace a pixel value of each second current pixel in the current specular reflection image with a corresponding fused pixel value, and use an image obtained through replacement as the target specular reflection image.

The statistical calculation includes at least one of average calculation, weighting calculation, or weighted average calculation. The average calculation refers to calculating an average of a plurality of numerical values. A plurality of means at least two. The weighting calculation refers to multiplying each of a plurality of numerical values by a corresponding weight to obtain weighted values respectively corresponding to the numerical values, and performing summation calculation on the weighted values respectively corresponding to the numerical values. A weighted value corresponding to a numerical value refers to a product of the numerical value and a corresponding weight. A result of the summation calculation is a result of the weighting calculation. A plurality of means at least two. The weighted average calculation refers to performing weighting calculation on a plurality of numerical values to obtain a weighting calculation result, performing summation on weights respectively corresponding to the numerical values to obtain a total weight, and calculating a ratio of the weighting calculation result to the total weight, where the ratio is a result of the weighted average calculation.

Operation 208. Perform image fusion on the target diffuse reflection image and the target specular reflection image, to obtain a target image.

Image fusion refers to fusing pixel values of pixels at identical positions in at least two images. The fusing the pixel values includes, but is not limited to, performing at least one of weighting calculation or summation calculation on the pixel values. The target image is an image finally generated by denoising the image rendered in real time. In a game scene, the target image is a video frame played in real time in a game playing process.

Specifically, the terminal may fuse pixel values of pixels at identical positions in the target diffuse reflection image and the target specular reflection image, to obtain fused pixel values respectively corresponding to pixels at positions. For example, if a pixel value of a pixel at a position (1, 1) in the target diffuse reflection image is g1, and a pixel value of a pixel at a position (1, 1) in the target specular reflection image is g2, weighting calculation or summation calculation may be performed on g1 and g2, and a calculation result is used as a fused pixel value corresponding to the pixel at the position (1, 1). The terminal may determine, as the target image, an image formed by the fused pixel values respectively corresponding to the pixels at the positions.

In some embodiments, the terminal may further acquire a current direct illumination image. The current direct illumination image is an image obtained by performing illumination rendering on the scene region observed at the current moment by using direct illumination. The current direct illumination image may be rendered by the terminal, or may be acquired by the terminal from the server. The terminal may denoise the current direct illumination image to obtain a target direct illumination image. For example, the terminal may denoise the current direct illumination image through at least one of spatial filtering or temporal filtering, to obtain the target direct illumination image. Spatial filtering or temporal filtering can implement denoising because both the spatial filtering and the temporal filtering are configured to adjust a pixel value of a pixel, to reduce noise in an image, that is, reduce odd display effects in the image, thereby achieving a denoising effect through filtering. The terminal may perform image fusion on the target diffuse reflection image, the target specular reflection image, and the target direct illumination image to obtain the target image.

FIG. 3 is a schematic diagram of obtaining a target image. In FIG. 3, “diffuse reflection indirect illumination” is configured for performing illumination rendering on a scene region observed at a current moment by using diffuse reflection indirect illumination, to generate a diffuse reflection image corresponding to the current moment, “specular reflection indirect illumination” is configured for performing illumination rendering on a scene region observed at a current moment by using specular reflection indirect illumination, to generate a specular reflection image corresponding to the current moment, and “direct illumination” is configured for performing illumination rendering on a scene region observed at a current moment by using direct illumination, to generate a direct illumination image corresponding to the current moment. “Spatial filtering 1” is configured for spatially filtering, that is, spatially denoising the diffuse reflection image corresponding to the current moment, to obtain a spatially denoised diffuse reflection image. The spatially denoised diffuse reflection image herein is the current diffuse reflection image. “Spatial filtering 2” is configured for spatially filtering the specular reflection image corresponding to the current moment, to obtain a spatially denoised specular reflection image. The spatially denoised specular reflection image herein is the current specular reflection image. “Spatial filtering 3” is configured for spatially filtering the direct illumination image corresponding to the current moment, to obtain a spatially denoised direct illumination image. “Temporal filtering 1” is configured for temporally filtering, that is, temporally denoising the spatially denoised diffuse reflection image, to obtain a temporally denoised diffuse reflection image. The temporally filtered diffuse reflection image herein is the target diffuse reflection image. “Temporal filtering 2” is configured for temporally filtering the spatially denoised specular reflection image, to obtain a temporally denoised specular reflection image. The temporally denoised specular reflection image herein is the target specular reflection image. “Temporal filtering 3” is configured for temporally filtering the spatially denoised direct illumination image, to obtain a temporally denoised direct illumination image. The temporally denoised direct illumination image herein is the target direct illumination image. “Image fusion” is configured for performing image fusion on the target diffuse reflection image, the target specular reflection image, and the target direct illumination image to obtain “denoised information”, that is, the target image. This application does not limit a sequence of obtaining the target diffuse reflection image, the target specular reflection image, and the target direct illumination image. For example, the target direct illumination image may be obtained first, and then the target diffuse reflection image and the target specular reflection image are obtained. Alternatively, the target diffuse reflection image, the target specular reflection image, and the target direct illumination image may be obtained simultaneously.

In the foregoing image denoising method, the current diffuse reflection image is denoised by using the historical diffuse reflection image to obtain a target diffuse reflection image; the current specular reflection image is denoised by using the historical specular reflection image to obtain a target specular reflection image; and image fusion is performed on the target diffuse reflection image and the target specular reflection image to obtain a target image, thereby separately denoising the current diffuse reflection image and the current specular reflection image. The indirect illumination includes diffuse reflection illumination and specular reflection illumination. Compared with directly denoising an image obtained through indirect illumination, the denoising the current diffuse reflection image and the current specular reflection image separately improves accuracy of denoising on the indirect illumination, thereby improving a real-time denoising effect, so that computer resources configured for supporting the denoising achieve a useful result, and waste of the computer resources is reduced. In addition, denoising can be performed on the current diffuse reflection image and the current specular reflection image in parallel, thereby improving denoising efficiency, reducing time for occupying the computer resources, and improving utilization of the computer resources.

In some embodiments, pixels in the current diffuse reflection image are first current pixels, and the denoising the current diffuse reflection image by using the historical diffuse reflection image, to obtain a target diffuse reflection image includes: mapping each of the first current pixels from a screen space to a world space, to obtain a world space point corresponding to each of the first current pixels; acquiring, for each of the first current pixels, coordinates of the world space point corresponding to the first current pixel at the historical moment in the world space, to obtain first historical world coordinates; mapping each of the first historical world coordinates from the world space to the screen space, to obtain screen space coordinates corresponding to each of the first historical world coordinates; determining, for each of the first current pixels, a first reference pixel corresponding to the first current pixel based on a pixel at screen space coordinates corresponding to the first historical world coordinates in the historical diffuse reflection image; and denoising the corresponding first current pixel in the current diffuse reflection image by using the first reference pixel, to obtain the target diffuse reflection image.

The first current pixel is a pixel in the current diffuse reflection image. The world space point is a point in the world space. The world space point corresponding to the first current pixel refers to a world space position corresponding to the first current pixel, that is, a point at world coordinates. The world space position is a position obtained by mapping the position of the first current pixel in the screen space to the world space. The world space point corresponding to the first current pixel belongs to the virtual object, and the virtual object to which the world space point belongs is also the virtual object to which the first current pixel belongs. For example, the world space point corresponding to the first current pixel belongs to an animal in the virtual scene, so that the first current pixel belongs to the animal. Because the virtual object may move, the world space point corresponding to the first current pixel may move. Therefore, a position of the world space point at the current moment may be different from a position of the world space point at the historical moment. Certainly, if the virtual object to which the world space point belongs does not move, the position of the world space point remains unchanged. The world coordinates of the world space point at the historical moment are configured for representing a position of the world space point at the historical moment. The first historical world coordinates are a position of the world space point corresponding to the first current pixel at the historical moment. Each position of the world space point is a position of the world space point in the world space. In the screen space and the world space, different coordinate systems are used, that is, coordinates are represented in different manners. There is a coordinate mapping relationship between the screen space and the world space. The coordinate mapping relationship is configured for mapping coordinates in the screen space to coordinates in the world space, and may also be configured for mapping coordinates in the world space to coordinates in the screen space. The mapping means conversion.

Specifically, the terminal may map coordinates of the first current pixel in the screen space to coordinates in the world space, to obtain first current world coordinates, and use a point at the first current world coordinates in the world space as the world space point corresponding to the first current pixel. The terminal may map the first historical world coordinates from the world space to the screen space to obtain screen space coordinates corresponding to the first historical world coordinates, and use a pixel at the screen space coordinates from the historical diffuse reflection image as a first historical pixel. For example, if the screen space coordinates are (2, 3), a pixel at the second row and the third column in the historical diffuse reflection image is used as the first historical pixel. The terminal may determine the first historical pixel as a first reference pixel corresponding to the first current pixel.

In some embodiments, for each first current pixel, the terminal may perform statistical calculation on the pixel value of the first current pixel and the pixel value of the first reference pixel, and determine a calculation result as the fused pixel value of the first current pixel. The statistical calculation includes, but is not limited to, at least one of average calculation, weighting calculation, or weighted average calculation. The terminal may obtain the target diffuse reflection image based on fused pixel values respectively corresponding to the first current pixels in the current diffuse reflection image. For example, the terminal may replace a pixel value of each first current pixel in the current diffuse reflection image with a corresponding fused pixel value, and use an image obtained through replacement as the target diffuse reflection image.

In this embodiment, a first reference pixel corresponding to the first current pixel is determined based on a pixel at screen space coordinates corresponding to the first historical world coordinates in the historical diffuse reflection image, and the corresponding first current pixel in the current diffuse reflection image is denoised by using the first reference pixel, to implement rapid denoising, thereby improving utilization of computer resources.

In some embodiments, the determining a first reference pixel corresponding to the first current pixel based on a pixel at screen space coordinates corresponding to the first historical world coordinates in the historical diffuse reflection image includes: using a pixel at the screen space coordinates corresponding to the first historical world coordinates in the historical diffuse reflection image as a first historical pixel; acquiring an object identifier of the first current pixel and an object identifier of the first historical pixel; and determining the first historical pixel as the first reference pixel corresponding to the first current pixel when the object identifier of the first current pixel is consistent with the object identifier of the first historical pixel.

The object identifier is configured for uniquely identifying the virtual object, the object identifier of the first current pixel is an object identifier of the virtual object to which the first current pixel belongs, and the object identifier of the first historical pixel is an object identifier of the virtual object to which the first historical pixel belongs.

Specifically, the terminal may acquire an object identifier of the first current pixel and an object identifier of the first historical pixel. The terminal may determine the first historical pixel as the first reference pixel corresponding to the first current pixel when the object identifier of the first current pixel is consistent with the object identifier of the first historical pixel. When the object identifier of the first current pixel is inconsistent with the object identifier of the first historical pixel, the first reference pixel may continue to be searched for (for a detailed process, refer to the following embodiment of determining the first reference pixel based on the first target world coordinates).

In this embodiment, when the object identifier of the first current pixel is consistent with the object identifier of the first historical pixel, it may indicate that the first historical pixel and the first current pixel belong to the same virtual object and represent the same position in the virtual object. Therefore, by denoising the first current pixel by using the first historical pixel as the first reference pixel, a color between two adjacent frames of images can be smooth, and a flicker situation during image switching can be reduced. Therefore, a better result is achieved by computer resources configured for supporting denoising, and waste of the computer resources configured for supporting denoising is reduced.

In some embodiments, the image denoising method further includes: mapping coordinates of the first current pixel in the screen space to coordinates in the world space, to obtain first current world coordinates; mapping coordinates of the first historical pixel in the screen space to coordinates in the world space when the object identifier of the first current pixel is inconsistent with the object identifier of the first historical pixel, to obtain second historical world coordinates; acquiring world coordinates of a world space point at the second historical world coordinates at the current moment, to obtain second current world coordinates; determining an offset between the first current world coordinates and the second current world coordinates, to obtain a first coordinate offset; offsetting the first historical world coordinates based on the first coordinate offset, to obtain first target world coordinates; mapping the first target world coordinates from the world space to coordinates in the screen space, to obtain screen space coordinates corresponding to the first target world coordinates; and determining a pixel at the screen space coordinates corresponding to the first target world coordinates in the historical diffuse reflection image as the first reference pixel corresponding to the first current pixel.

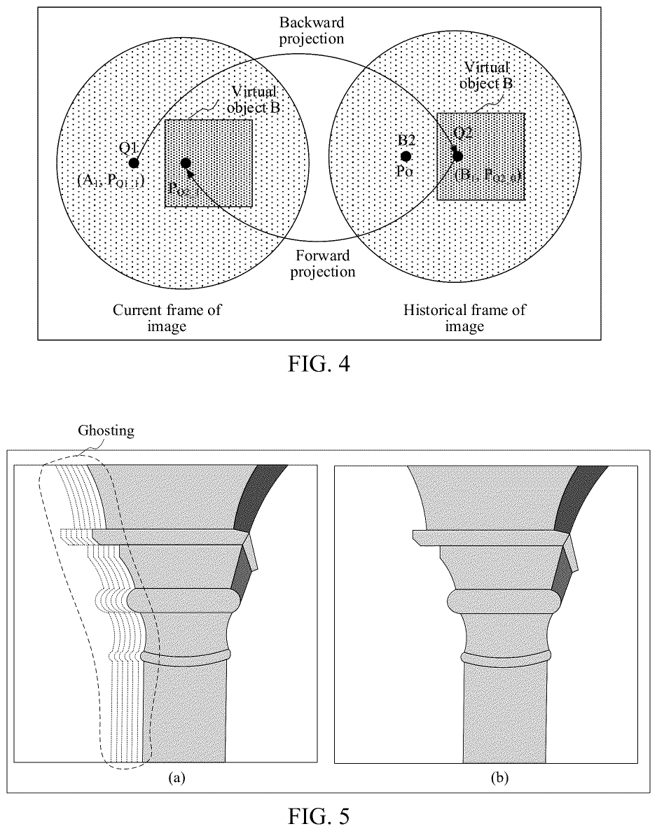

The first current world coordinates are world coordinates corresponding to the first current pixel. The second historical world coordinates are world coordinates corresponding to the first historical pixel. The world space is a three-dimensional space, and during observation, some virtual object is blocked by another virtual object. Therefore, after coordinates of a plurality of different points in the world space are converted into in the screen space, coordinates obtained through conversion may be the same screen space coordinates, that is, the plurality of points in the world space may correspond to a position in the screen space, but only a point that is not blocked is displayed in the screen space. The coordinates in the screen space are converted into the world space to obtain unique coordinates. The unique coordinates are coordinates of the point that is not blocked during observation. Therefore, the first historical world coordinates are mapped to the first historical pixel in the screen space, and the second historical world coordinates are also mapped to the first historical pixel in the screen space, but the first historical world coordinates and the second historical world coordinates may be different. For example, when the object identifier of the first current pixel is inconsistent with the object identifier of the first historical pixel, a point at the first historical world coordinates is blocked, and a point at the second historical world coordinates is not blocked. A case that the object identifier of the first current pixel is inconsistent with the object identifier of the first historical pixel is described below with reference to FIG. 4. As shown in FIG. 4, a virtual object B and a virtual object A exist in a current frame of image and a historical frame of image, and a world space point Q1 on a virtual object is drawn in the figure for ease of description. First current world coordinates corresponding to a first current pixel A1 in the current frame of image is PQ1_1, a world space point at the first current world coordinates PQ1_1 is Q1, and the world space point is Q1 belonging to the virtual object A. A position of the world space point Q1 in the world space at a historical moment, that is, first historical world coordinates, is PQ1_0. In addition, at the historical moment, the world space point Q1 at the first historical world coordinates PQ1_0 is blocked by the virtual object B. Therefore, if the terminal maps the first historical world coordinates from the world space to the screen space to obtain screen space coordinates corresponding to the first historical world coordinates, and determines a pixel at the screen space coordinates from a historical diffuse reflection image to obtain a first historical pixel B1, the first historical pixel is not a real pixel of the world space point Q1, but a pixel of the virtual object B that blocks the world space point Q1. That is, the world space point Q1 actually has no corresponding pixel in the historical frame of image, an object identifier corresponding to the first historical pixel B1 is an object identifier of the virtual object B, and an object identifier corresponding to the first current pixel A1 is an object identifier of the virtual object A. In this case, if the first historical pixel is still used as the first reference pixel for denoising, ghosting is likely to occur, and a tailing effect is generated due to the ghosting especially when the object moves quickly. As shown in FIG. 5, (a) of FIG. 5 is an image captured from a picture obtained by performing real-time rendering by using a conventional image denoising method. It can be seen that the image has ghosting. (b) of FIG. 5 is an image captured from a picture obtained by performing real-time rendering by using the image denoising method of this application. It can be seen that the image has no ghosting.

Specifically, when the object identifier of the first current pixel is inconsistent with the object identifier of the first historical pixel, the terminal may determine world coordinates corresponding to the first historical pixel, to obtain second historical world coordinates, for example, may map the coordinates of the first historical pixel in the screen space to coordinates in the world space according to a depth value of the first historical pixel and the coordinates of the first historical pixel in the screen space, to obtain the second historical world coordinates. As shown in FIG. 4, the world coordinates of the first historical pixel B1 are PQ2_0, that is, the second historical world coordinates are PQ2_0. The terminal may determine world coordinates of a world space point at the second historical world coordinates at the current moment, to obtain second current world coordinates. For example, a world space point at the second historical world coordinates PQ2_0 is Q2, and world coordinates of the world space point Q2 at the current moment are PQ2_1, that is, the second current world coordinates are PQ2_1. The terminal may calculate an offset between the first current world coordinates and the second current world coordinates, to obtain a first coordinate offset. For example, an offset between the first current world coordinates PQ1_1 and the second current world coordinates PQ2_1 is PQ1_1−PQ2_1. The terminal may obtain the first target world coordinates by offsetting the first historical world coordinates by the first coordinate offset. For example, the first target world coordinates Po=PQ1_0+(PQ1_1−PQ2_1).

In some embodiments, when the first target world coordinates are obtained, the terminal may map the first target world coordinates from the world space to the screen space to obtain a screen space position corresponding to the first target world coordinates, and determine a pixel at the screen space position from the historical diffuse reflection image as the first reference pixel corresponding to the first current pixel. The screen space is a two-dimensional space in which a screen is located. A size of the screen space is a size of the screen in pixels. For example, in FIG. 4, a pixel at the screen space position corresponding to the first target world coordinates Po in the historical diffuse reflection image is determined as B2, and B2 is used as the first reference pixel corresponding to the first current pixel. The first current world coordinates are mapped to the first historical world coordinates (which may be understood as backward mapping), the second historical world coordinates are mapped to the second current world coordinates (which may be understood as forward mapping), a distance between the first current world coordinates and the first historical world coordinates reflects a motion vector of the world space point corresponding to the first current pixel, and a distance between the second historical world coordinates and the second current world coordinates reflects a motion vector of the world space point corresponding to the first historical pixel. Therefore, a process of determining the first reference pixel may be understood as using a bidirectional motion vector. Therefore, a process of obtaining the first reference pixel B2 may be represented as: B2=bidirectional motion vector (A1).

In this embodiment, when the object identifier of the first current pixel is inconsistent with the object identifier of the first historical pixel, a pixel at the screen space coordinates corresponding to the first target world coordinates in the historical diffuse reflection image is determined as the first reference pixel corresponding to the first current pixel, thereby reducing ghosting. Therefore, a better result is achieved by computer resources configured for supporting denoising, and waste of the computer resources configured for supporting denoising is reduced.

In some embodiments, the determining a pixel at the screen space coordinates corresponding to the first target world coordinates in the historical diffuse reflection image as the first reference pixel corresponding to the first current pixel includes: using the pixel at the screen space coordinates corresponding to the first target world coordinates in the historical diffuse reflection image as a candidate pixel; acquiring an object identifier of the candidate pixel; and determining the candidate pixel as the first reference pixel corresponding to the first current pixel when the object identifier of the first current pixel is consistent with the object identifier of the candidate pixel.

The candidate pixel is a pixel corresponding to the first target world coordinates in the historical diffuse reflection image, that is, a pixel corresponding to the first target world coordinates after being converted from the world space to the screen space. The object identifier of the first current pixel refers to an identifier of the virtual object to which the first current pixel belongs. The object identifier of the first reference pixel refers to an identifier of the virtual object to which the first reference pixel belongs. When a pixel is configured for representing a virtual object, the pixel belongs to the virtual object. For example, if an image includes an animal, pixels configured for representing the animal belong to the animal.

Specifically, when the object identifier of the first current pixel is consistent with the object identifier of the candidate pixel, it may indicate that the first current pixel and the candidate pixel belong to the same virtual object, so that the candidate pixel may reflect an illumination situation of a world space point corresponding to the first current pixel. Therefore, determining the candidate pixel as the first reference pixel corresponding to the first current pixel can improve accuracy of denoising and reduce ghosting.

In some embodiments, when the object identifier of the first current pixel is inconsistent with the object identifier of the candidate pixel, if the first current pixel is denoised by using the candidate pixel, ghosting is likely to occur. Therefore, when the object identifier of the first current pixel is inconsistent with the object identifier of the candidate pixel, the terminal determines that the first reference pixel corresponding to the first current pixel does not exist. When the first reference pixel corresponding to the first current pixel is not found, the terminal might not denoise the first current pixel, to reduce ghosting.

In this embodiment, when the object identifier of the first current pixel is consistent with the object identifier of the candidate pixel, the candidate pixel is determined as the first reference pixel corresponding to the first current pixel. That is, the candidate pixel is not determined as the first reference pixel corresponding to the first current pixel when the object identifier of the first current pixel is inconsistent with the object identifier of the candidate pixel, thereby reducing ghosting. Therefore, a better result is achieved by computer resources configured for supporting denoising, and waste of the computer resources configured for supporting denoising is reduced.

In some embodiments, the denoising the corresponding first current pixel in the current diffuse reflection image by using the first reference pixel, to obtain the target diffuse reflection image includes: acquiring, for each of the first current pixels, an attribute similarity between the first current pixel and the corresponding first reference pixel; determining a weight of the first reference pixel corresponding to the first current pixel based on the attribute similarity; fusing, for each of the first current pixels, a pixel value of the first current pixel and a pixel value of the corresponding first reference pixel by using the weight of the first reference pixel corresponding to the first current pixel, to obtain a fused pixel value of the first current pixel; and obtaining the target diffuse reflection image based on fused pixel values respectively corresponding to the first current pixels in the current diffuse reflection image.

The attribute similarity is configured for representing an attribute similarity between the first current pixel and the corresponding first reference pixel. The attribute includes, but is not limited to, at least one of a normal, a depth, a material, or the like. An attribute of a pixel refers to an attribute at a world space point of the pixel. For example, the normal of the first current pixel refers to a normal at the world space point corresponding to the first current pixel. Each pixel may store an attribute value corresponding to each attribute. The attribute value of the normal may be a direction vector of the normal or an angle representing a direction of the normal. The attribute value of the depth is a depth value. The attribute value of the material is a material representation value. The material representation value is configured for representing a feature of the material, for example, representing at least one of roughness of the material or reflectivity of the material. The depth value is configured for reflecting a distance between the position of the pixel in the world space and the observation position. For example, the depth value of the first current pixel is configured for reflecting a distance between the position of the first current pixel in the world space and the observation position at the current moment, and the depth value of the first reference pixel is configured for reflecting a distance between the position of the first reference pixel in the world space and the observation position at the historical moment. A larger depth value indicates a longer distance. A weight of the first reference pixel corresponding to the first current pixel may be referred to as a reference fusion weight. The reference fusion weight is positively correlated with the attribute similarity. A larger attribute similarity indicates a larger reference fusion weight.

Specifically, for each first current pixel, the terminal may determine a difference between the first current pixel and the corresponding first reference pixel in normal directions, to obtain a normal difference. For example, the terminal may determine a direction vector of a normal of the first current pixel to obtain a first direction vector, determine a direction vector of a normal of the first reference pixel to obtain a second direction vector, and calculate an angle between the first direction vector and the second direction vector to obtain a normal difference based on the angle. The direction vector of the normal is configured for representing a direction of the normal. The normal difference is positively correlated with the angle. A larger angle indicates a larger normal difference. The terminal may determine a difference between the first current pixel and the corresponding first reference pixel in depth values, to obtain a depth difference. For example, the terminal may determine a depth value of the first current pixel to obtain a first depth value, determine a depth value of the first reference pixel corresponding to the first current pixel to obtain a second depth value, and calculate a difference between the first depth value and the second depth value to obtain a depth difference. The difference between the first depth value and the second depth value is positively correlated with the depth difference. For example, the terminal may use the difference between the first depth value and the second depth value as the depth difference, or perform linear transformation or nonlinear transformation on the difference between the first depth value and the second depth value, and use a result obtained through transformation as the depth difference. The first depth value is configured for reflecting a distance between the position of the first current pixel in the world space and the observation position at the current moment, and the second depth value is configured for reflecting a distance between the position of the first reference pixel in the world space and the observation position at the historical moment. A larger depth value indicates a longer distance. The terminal may determine a difference between the first current pixel and the corresponding first reference pixel in material representation values, to obtain a material difference. For example, the terminal may determine a material representation value corresponding to the first current pixel to obtain a first material representation value, determine a material representation value corresponding to the first reference pixel to obtain a second material representation value, and calculate a difference between the first material representation value and the second material representation value to obtain a material difference. The difference between the first material representation value and the second material representation value is positively correlated with the material difference. For example, the terminal may use the difference between the first material representation value and the second material representation value as the material difference, or perform linear transformation or nonlinear transformation on the difference between the first material representation value and the second material representation value, and use a result obtained through transformation as the material difference. The terminal may determine the attribute similarity between the first current pixel and the corresponding first reference pixel based on at least one of the normal difference, the depth difference, or the material difference. The attribute similarity is negatively correlated with each of the normal difference, the depth difference, and the material difference. The attribute similarity between the first current pixel and the corresponding first reference pixel may be referred to as a first attribute similarity. The reference fusion weight of the first reference pixel may be referred to as a first attribute similarity.

In some embodiments, the terminal may determine the first attribute similarity as the first reference fusion weight. For example, w₁=evaluation similarity (m₁, p₁), where the evaluation similarity is configured for calculating the first attribute similarity, w₁ represents the first reference fusion weight, m₁ represents the first current pixel, and p₁ represents the first reference pixel. Alternatively, the terminal may perform linear or non-linear calculation on the first attribute similarity, and use a calculation result as the first reference fusion weight. The first reference fusion weight is positively correlated with the first attribute similarity.

In some embodiments, the terminal may determine a first current fusion weight based on the first reference fusion weight, where the first current fusion weight is a weight of the first current pixel. Specifically, the terminal may calculate a difference between a preset numerical value and the first reference fusion weight, and determine the calculated difference as the first current fusion weight. The preset numerical value may be set as required. For example, when the first reference fusion weight is in a value range of 0 to 1, the preset numerical value is, for example, 1. For example, if the first reference fusion weight is w₁, and the preset numerical value is 1, a current fusion weight w₀₁=1−w₁. The terminal may perform weighting calculation on the pixel value of the first current pixel and the pixel value of the corresponding first reference pixel by using the first reference fusion weight and the first current fusion weight, to obtain the fused pixel value of the first current pixel.

In some embodiments, for each first current pixel, the terminal may demodulate a pixel value of the first current pixel to obtain corresponding irradiance. Specifically, the terminal may calculate a ratio of the pixel value of the first current pixel to an albedo, and determine the calculated ratio as the irradiance corresponding to the first current pixel. Similarly, the terminal may demodulate the pixel value of the first reference pixel to obtain irradiance corresponding to the first reference pixel. The albedo generally refers to a ratio or a fraction of reflected radiation of an object to total radiation received by a surface of the object, that is, a ratio of reflected radiation to total incident radiation. Irradiance is power per unit area of electromagnetic radiation incident on a curved surface, and is usually configured for representing an intensity of illumination received by a diffuse reflection surface. The pixel value may also be understood as a color value. For example, I(i, x(i))=P(i, x(i))/A(x(i)). x(i) represents an i^{th} pixel in the current diffuse reflection image, that is, x(i) is an i^{th} first current pixel, P(i, x(i)) is a pixel value of the i^{th} first current pixel, A(x(i)) is an albedo corresponding to the i^{th} first current pixel, and I(i, x(i)) is irradiance corresponding to the i^{th} first current pixel. The terminal may perform weighting calculation on the irradiance of the first current pixel and the irradiance of the first reference pixel by using the first reference fusion weight and the first current fusion weight, and determine a calculation result as the fused irradiance corresponding to the first current pixel. For example, the fused irradiance corresponding to the first current pixel may be calculated by using the following formula.

$${I}^{′} = \frac{{w}_{01} * I + {w}_{1} * {I}_{1}}{{w}_{01} + {w}_{1}}$$

I′ represents the fused irradiance of the first current pixel, I represents the irradiance of the first current pixel, I₁ represents the irradiance of the first reference pixel, w₀₁ represents the first current fusion weight, and w₁ represents the first reference fusion weight.

In some embodiments, the terminal may modulate the fused irradiance of the first current pixel to obtain the fused pixel value corresponding to the first current pixel. For example, the terminal may multiply the fused irradiance by the albedo, and use a result of the multiplication as the fused pixel value. For example, P′(i, x(i))=I′ *A(x(i)). P′(i, x(i)) represents the fused pixel value of the first current pixel.

In some embodiments, the terminal may replace a pixel value of each first current pixel in the current diffuse reflection image with a corresponding fused pixel value, and use an image obtained through replacement as the target diffuse reflection image.

In this embodiment, a larger attribute similarity indicates that the first reference pixel is closer to the first current pixel in illumination. Therefore, a weight of the first reference pixel corresponding to the first current pixel is determined based on the attribute similarity, to obtain a reference fusion weight, thereby improving accuracy of the reference fusion weight. Therefore, a better result is achieved by computer resources configured for supporting denoising, and waste of the computer resources configured for supporting denoising is reduced.

In some embodiments, pixels in the current specular reflection image are second current pixels, and the denoising the current specular reflection image by using the historical specular reflection image, to obtain a target specular reflection image includes: mapping, for each second current pixel, coordinates of the second current pixel in the screen space to the world space, to obtain a target space position; acquiring an incident light transmission distance corresponding to the target space position, the incident light transmission distance being a transmission di stance of a target incident light ray at the target space position, the target incident light ray being reflected at the target space position, and a reflected light ray being observed at the current moment; determining a position offset based on an observation direction at the current moment and the incident light transmission distance; offsetting the target space position by using the position offset, to obtain a virtual image point position corresponding to the second current pixel; and denoising the current specular reflection image based on the virtual image point position and the historical specular reflection image, to obtain the target specular reflection image.

The second current pixel is a pixel in the current specular reflection image. The virtual image point position is a position of the virtual image point corresponding to the second current pixel. Any two light rays emitted by any point on the virtual object in the virtual scene are reflected on a plane on which specular reflection occurs to obtain two reflected light rays, and an intersection point between reverse extension lines of the two reflected light rays is a virtual image point corresponding to the point on the virtual object. A set of virtual image points respectively corresponding to points on an object is a virtual image of the object. For a virtual object in the world space, if one of two light rays emitted by a point on the virtual object is specularly reflected at the world space point corresponding to the second current pixel, and a reflected light ray of the light ray is observed at the current moment, two reflected light rays obtained after the two light rays are respectively specularly reflected are determined, and an intersection point between reverse extension lines of the two reflected light rays is the virtual image point corresponding to the second current pixel. The target space position is a world space position corresponding to the second current pixel. The world space position is a position in the world space, and may be represented by coordinates. The incident light transmission distance is a transmission distance of a target incident light ray, the target incident light ray is a light ray incident at the target spatial position, the target incident light ray is reflected at the target space position, and a reflected light ray is observed at the current moment.

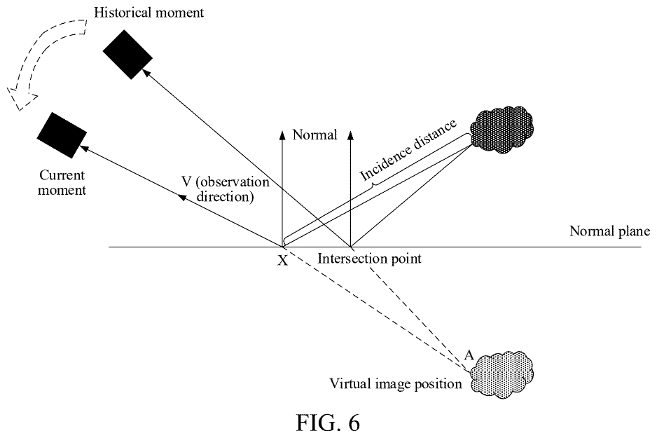

Specifically, the terminal may determine a world space position corresponding to the second current pixel to obtain a target space position, and determine an incident light transmission distance corresponding to the target space position. The incident light transmission distance is a transmission distance of the target incident light ray at the target space position. The target incident light ray is reflected at the target space position, and a reflected light ray is observed at the current moment. The terminal may move the incident light transmission distance in the observation direction at the current moment based on the target space position, and determine a position reached through movement as the virtual image point position corresponding to the second current pixel. FIG. 6 illustrates a specular reflection phenomenon, where X is a target space position, a virtual object and a virtual image of the virtual object are respectively located on two sides of a normal plane at X, the virtual object and the virtual image of the virtual object are symmetrical relative to the normal plane, and the “incidence distance” is an incident light transmission distance. The terminal may move the incidence distance in an observation direction at a current moment based on the target space position X to obtain a virtual image point position A.

In some embodiments, the terminal may map the second current pixel from the screen space to the world space, to determine the world space position corresponding to the second current pixel. The terminal may determine a direction vector corresponding to the observation direction at the current moment, and calculate a product of the direction vector and the incident light transmission distance to obtain a position offset. The terminal may offset the target space position by the position offset, and determine the offset position as the virtual image point position corresponding to the second current pixel. For example, a virtual image point position Xᵥᵢᵣₜᵤₐₗ=X−V*hitdist, where Xᵥᵢᵣₜᵤₐₗ represents the virtual image point position, X represents the target space position, V*hitdist represents a position offset, V is a direction vector, and hitdist is the incident light transmission distance.

In this embodiment, the target space position is offset by using the position offset, to obtain a virtual image point position corresponding to the second current pixel, the virtual image point position is accurately calculated, and therefore the current specular reflection image is denoised based on the virtual image point position and the historical specular reflection image, to improve denoising accuracy. Therefore, a better result is achieved by computer resources configured for supporting denoising, and waste of the computer resources configured for supporting denoising is reduced.

In some embodiments, the denoising the current specular reflection image based on the virtual image point position and the historical specular reflection image, to obtain the target specular reflection image includes: determining a connecting line between an observation position at the historical moment and the virtual image point position, to obtain a target connecting line; determining a position at which the target connecting line intersects with a normal plane of the second current pixel, to obtain a target intersection point position; mapping the target intersection point position from the world space to the screen space, to obtain screen space coordinates corresponding to the target intersection point position; determining a pixel at the screen space coordinates corresponding to the target intersection point position in the historical specular reflection image as a second reference pixel of the second current pixel; and denoising the corresponding second current pixel in the current specular reflection image by using the second reference pixel, to obtain the target specular reflection image.

The target connecting line is a connecting line between the observation position at the historical moment and the virtual image point position. The observation position at the historical moment refers to a position of the virtual camera in the world space at the historical moment. The target intersection point position is a position at which the target connecting line intersects with the normal plane of the second current pixel.

Specifically, the terminal may determine a position at which the target connecting line intersects with a normal plane of the second current pixel, to obtain a target intersection point position. As shown in FIG. 6, the “intersection point” is an intersection point between the target connecting line and the normal plane, and a position of the intersection point is the target intersection point position. The terminal may determine a pixel corresponding to the target intersection point position in the historical specular reflection image as the second reference pixel of the second current pixel. The second reference pixel obtained in this embodiment is a pixel that hits an imaging point (that is, a point in the virtual image) and has the strongest specular reflection. Therefore, the method for determining the second reference pixel provided in this embodiment may be understood as a method for determining the second reference pixel by using a specular motion vector. The specular motion vector is configured for finding a pixel that also hits an imaging point and has the strongest specular reflection in a historical frame of image. Conventional temporal filtering has a problem of excessive blurring. The excessive blurring causes a specular reflection signal to lose high-frequency information more easily. By using the method for determining a reference pixel for denoising by using a specular motion vector provided in this application, loss of high-frequency information can be effectively reduced, thereby improving denoising quality of specular reflection indirect illumination. Therefore, a better result is achieved by computer resources configured for supporting denoising, and waste of the computer resources configured for supporting denoising is reduced.

In some embodiments, for each second current pixel, the terminal may determine an attribute similarity between the second current pixel and the corresponding second reference pixel, to obtain a second attribute similarity. The terminal may determine a weight of the second reference pixel, that is, a second reference fusion weight, based on the second attribute similarity, and the terminal may use the second attribute similarity as the second reference fusion weight. For example, w₂=evaluation similarity (m₂, p₂), where the evaluation similarity is configured for calculating the second attribute similarity, w₂ represents the second reference fusion weight, m₂ represents the second current pixel, and p₂ represents the second reference pixel. The terminal may determine to perform weighting calculation on the pixel value of the second current pixel and the pixel value of the corresponding second reference pixel by using the second reference fusion weight, to obtain the fused pixel value of the second current pixel. The terminal may obtain the target specular reflection image based on fused pixel values respectively corresponding to the second current pixels in the current specular reflection image. For example, the terminal may replace a pixel value of each second current pixel in the current specular reflection image with a corresponding fused pixel value, and use an image obtained through replacement as the target specular reflection image.

In this embodiment, a position at which the target connecting line intersects with the normal plane of the second current pixel is determined, to obtain a target intersection point position, and a pixel corresponding to the target intersection point position in the historical specular reflection image is determined as the second reference pixel of the second current pixel. Therefore, the second reference pixel is a pixel that hits the imaging point and has the strongest specular reflection, so that a pixel value at the second reference pixel can fully represent a specular reflection signal. Therefore, performing denoising by using the second reference pixel improves accuracy of denoising. Therefore, a better result is achieved by computer resources configured for supporting denoising, and waste of the computer resources configured for supporting denoising is reduced. The second reference pixel is a pixel that hits the imaging point and has the strongest specular reflection. Therefore, a process of determining the second reference pixel may also be understood as using a specular motion vector. Therefore, a process of obtaining the second reference pixel C1 may be represented as: C1=specular motion vector (A2). A2 represents the second current pixel, and C1 represents the third reference pixel.

In some embodiments, pixels in the current specular reflection image are second current pixels, and the denoising the current specular reflection image by using the historical specular reflection image, to obtain a target specular reflection image includes: mapping each of the second current pixels from a screen space to a world space, to obtain a world space point corresponding to each of the second current pixels; acquiring, for each of the second current pixels, coordinates of the world space point corresponding to the second current pixel at the historical moment in the world space, to obtain third historical world coordinates; mapping each of the third historical world coordinates from the world space to coordinates in the screen space, to obtain screen space coordinates corresponding to each of the third historical world coordinates; determining, for each of the second current pixels, a third reference pixel corresponding to the second current pixel based on a pixel at screen space coordinates corresponding to the third historical world coordinates in the historical specular reflection image; and denoising the corresponding second current pixel in the current specular reflection image based on the third reference pixel, to obtain the target specular reflection image.

Specifically, a principle of determining the third reference pixel is the same as a principle of determining the first reference pixel. The terminal may map the third historical world coordinates from the world space to the screen space to obtain screen space coordinates corresponding to the third historical world coordinates, and determine a pixel at the screen space coordinates from the historical specular reflection image to obtain a second historical pixel. The terminal may determine the second historical pixel as a third reference pixel corresponding to the second current pixel.

In some embodiments, for each second current pixel, the terminal may perform statistical calculation on the pixel value of the second current pixel and the pixel value of the third reference pixel, and determine a calculation result as the fused pixel value of the second current pixel. The statistical calculation includes, but is not limited to, at least one of average calculation or weighting calculation. Specifically, for each second current pixel, the terminal may determine an attribute similarity between the second current pixel and the corresponding first reference pixel, to obtain a third attribute similarity, and determine a weight of the third reference pixel corresponding to the second current pixel based on the third attribute similarity, to obtain a third reference fusion weight, and the terminal may use the third attribute similarity as a third reference fusion weight. For example, w₃=evaluation similarity (m₂, p₃), where the evaluation similarity is configured for calculating the third attribute similarity, w₃ represents the third reference fusion weight, m₂ represents the second current pixel, and p₃ represents the third reference pixel. Fusion such as weighting calculation is performed on the pixel value of the second current pixel and the pixel value of the corresponding third reference pixel by using the third reference fusion weight, to obtain the fused pixel value of the second current pixel.

In some embodiments, the terminal may obtain the target specular reflection image based on fused pixel values respectively corresponding to the second current pixels in the current specular reflection image. For example, the terminal may replace a pixel value of each second current pixel in the current specular reflection image with a corresponding fused pixel value, and use an image obtained through replacement as the target specular reflection image.

In some embodiments, for each second current pixel, the terminal may determine a fused pixel value of the second current pixel by using both the corresponding second reference pixel and the third reference pixel. In this way, the second current pixel is denoised in combination with the second reference pixel and the third reference pixel, thereby improving denoising accuracy. Specifically, the terminal may determine a weight of the second current pixel based on the second reference fusion weight and the third reference fusion weight to obtain the second current fusion weight, and perform weighting calculation on the pixel value of the second current pixel, the pixel value of the second reference pixel, and the pixel value of the third reference pixel by using the second reference fusion weight, the third reference fusion weight, and the second current fusion weight, to obtain the fused pixel value corresponding to the second current pixel. For example, the fused pixel value corresponding to the second current pixel may be calculated by using the following formula.

$${p}_{02}^{′} = \frac{{w}_{02} * {p}_{02} + {w}_{2} * {p}_{2} + {w}_{3} * {p}_{3}}{{w}_{02} + {w}_{2} + {w}_{3}}$$

W₀₂ is the second current fusion weight, and w₀₂=1−w₁-w₂. w₂ is the second reference fusion weight, w₃ is the third reference fusion weight, P₀₂ is the pixel value of the second current pixel, P₂ is the pixel value of the second reference pixel, and P₃ is the pixel value of the third reference pixel. P₀₂ is the fused pixel value corresponding to the second current pixel.

In this embodiment, a third reference pixel corresponding to the second current pixel is determined based on a pixel at screen space coordinates corresponding to the third historical world coordinates in the historical specular reflection image, and the corresponding second current pixel in the current diffuse reflection image is denoised by using the third reference pixel, to implement rapid denoising, thereby improving utilization of computer resources.

In some embodiments, the determining a third reference pixel corresponding to the second current pixel based on a pixel at screen space coordinates corresponding to the third historical world coordinates in the historical specular reflection image includes: determining a pixel at the screen space coordinates corresponding to the third historical world coordinates in the historical specular reflection image as a second historical pixel; acquiring an object identifier of the second current pixel and an object identifier of the second historical pixel; and determining the second historical pixel as the third reference pixel corresponding to the second current pixel when the object identifier of the second current pixel is consistent with the object identifier of the second historical pixel.

The object identifier of the second current pixel is an object identifier of the virtual object to which the second current pixel belongs, and the object identifier of the second historical pixel is an object identifier of the virtual object to which the second historical pixel belongs.

Specifically, the terminal may acquire an object identifier of the second current pixel and an object identifier of the second historical pixel. The terminal may determine the second historical pixel as the third reference pixel corresponding to the second current pixel when the object identifier of the second current pixel is consistent with the object identifier of the second historical pixel. When the object identifier of the second current pixel is inconsistent with the object identifier of the second historical pixel, the third reference pixel may continue to be searched for (for a detailed process, refer to the following embodiment of determining the third reference pixel based on the second target world coordinates).

In this embodiment, when the object identifier of the second current pixel is consistent with the object identifier of the second historical pixel, it may indicate that the second historical pixel and the second current pixel belong to the same virtual object and represent the same position in the virtual object. Therefore, by denoising the third current pixel by using the second historical pixel as the second reference pixel, a color between two adjacent frames of images can be smooth, and a flicker situation during image switching can be reduced. Therefore, a better result is achieved by computer resources configured for supporting denoising, and waste of the computer resources configured for supporting denoising is reduced.

In some embodiments, the image denoising method further includes: mapping coordinates of the second current pixel in the screen space to coordinates in the world space, to obtain third current world coordinates; mapping coordinates of the second historical pixel in the screen space to coordinates in the world space when the object identifier of the second current pixel is inconsistent with the object identifier of the second historical pixel, to obtain fourth historical world coordinates; acquiring world coordinates of a world space point at the fourth historical world coordinates at the current moment, to obtain fourth current world coordinates; using an offset between the third current world coordinates and the fourth current world coordinates as a second coordinate offset; offsetting the third historical world coordinates based on the second coordinate offset, to obtain second target world coordinates; mapping the second target world coordinates from the world space to coordinates in the screen space, to obtain screen space coordinates corresponding to the second target world coordinates; and determining a pixel at the screen space coordinates corresponding to the second target world coordinates in the historical specular reflection image as the third reference pixel corresponding to the second current pixel.

The third current world coordinates are world coordinates corresponding to the second current pixel. The fourth historical world coordinates are world coordinates corresponding to the second historical pixel. For a case that the object identifier of the second current pixel is inconsistent with the object identifier of the second historical pixel, reference may be made to the foregoing “case that the object identifier of the first current pixel is inconsistent with the object identifier of the first historical pixel”.

Specifically, when the object identifier of the second current pixel is inconsistent with the object identifier of the second historical pixel, the terminal may determine world coordinates corresponding to the second historical pixel, to obtain fourth historical world coordinates. The terminal may determine world coordinates of a world space point at the fourth historical world coordinates at the current moment, to obtain fourth current world coordinates. An offset between the third current world coordinates and the fourth current world coordinates is calculated, to obtain a second coordinate offset. The terminal may offset the third historical world coordinates by the second coordinate offset, to obtain the second target world coordinates. When the second target world coordinates are obtained, the terminal may determine a pixel corresponding to the second target world coordinates in the historical specular reflection image as the third reference pixel corresponding to the second current pixel.

In some embodiments, the candidate pixel in the operation of “determining a pixel corresponding to the first target world coordinates in the historical diffuse reflection image, to obtain a candidate pixel” may be denoted as the first candidate pixel. The terminal may determine a pixel corresponding to the second target world coordinates in the historical specular reflection image, to obtain a second candidate pixel, and determine the second candidate pixel as the third reference pixel corresponding to the second current pixel when the object identifier of the second current pixel is consistent with the object identifier of the second candidate pixel. Similar to the foregoing determining the first reference pixel, a process of determining the third reference pixel may also be understood as using a bidirectional motion vector. Therefore, a process of obtaining the third reference pixel C2 may be represented as: C2=bidirectional motion vector (A2). A2 represents the second current pixel, and C2 represents the third reference pixel.

In this embodiment, when the object identifier of the second current pixel is inconsistent with the object identifier of the second historical pixel, a pixel at the screen space coordinates corresponding to the second target world coordinates in the historical specular reflection image is determined as the third reference pixel corresponding to the second current pixel, thereby reducing ghosting. Therefore, a better result is achieved by computer resources configured for supporting denoising, and waste of the computer resources configured for supporting denoising is reduced.

In some embodiments, the performing image fusion on the target diffuse reflection image and the target specular reflection image, to obtain a target image includes: acquiring a current direct illumination image; the current direct illumination image being an image obtained by performing illumination rendering on the scene region observed at the current moment by using direct illumination; denoising the current direct illumination image to obtain a target direct illumination image; and performing image fusion on the target diffuse reflection image, the target specular reflection image, and the target direct illumination image to obtain the target image.

Specifically, the current direct illumination image may be generated by the terminal. For example, the terminal may perform illumination rendering on a scene region observed at a current moment, and determine the rendered image as the current direct illumination image. Certainly, the current direct illumination image may alternatively be acquired by the terminal from the server.

In some embodiments, the terminal may spatially filter the current direct illumination image, to obtain a spatially denoised direct illumination image, and the terminal may determine the spatially denoised direct illumination image as the target direct illumination image. Alternatively, the terminal may temporally denoise the spatially denoised direct illumination image, and determine the temporally denoised image as the target direct illumination image.

In some embodiments, when the target diffuse reflection image, the target specular reflection image, and the target direct illumination image are obtained, the terminal may perform image fusion on the target diffuse reflection image, the target specular reflection image, and the target direct illumination image, and determine the fused image as the target image.

In this embodiment, image fusion is performed on the target diffuse reflection image, the target specular reflection image, and the target direct illumination image to obtain the target image, so that each type of illumination in the target image is sufficiently denoised, thereby improving a denoising effect on the target image. Therefore, a better result is achieved by computer resources configured for supporting denoising, and waste of the computer resources configured for supporting denoising is reduced.

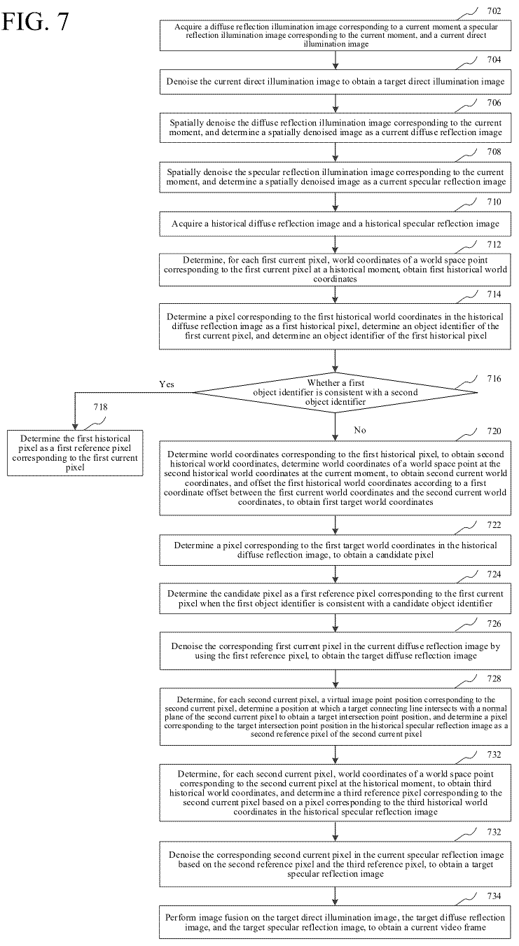

In some embodiments, as shown in FIG. 7, an image denoising method is provided. The method may be performed by a terminal, or may be jointly performed by a terminal and a server. An example in which the method is applied to a terminal is used for description, and the method includes the following operations:

Operation 702. Acquire a diffuse reflection image corresponding to a current moment, a specular reflection image corresponding to the current moment, and a current direct illumination image.

Operation 704. Denoise the current direct illumination image to obtain a target direct illumination image.

Operation 706. Spatially denoise the diffuse reflection image corresponding to the current moment, and determine a spatially denoised image as a current diffuse reflection image.

Operation 708. Spatially denoise the specular reflection image corresponding to the current moment, and determine a spatially denoised image as a current specular reflection image.

Operation 710. Acquire a historical diffuse reflection image and a historical specular reflection image.

Operation 712. Determine, for each first current pixel, world coordinates of a world space point corresponding to the first current pixel at a historical moment, obtain first historical world coordinates.

The first current pixel is a pixel in the current diffuse reflection image. The first historical world coordinates may be calculated by using a formula X(i−1)=Ta(i−1)·(Ta(i)*)¹·X(i). X(i−1) represents the first historical world coordinates, X(i) represents first current world coordinates, the first current world coordinates are world coordinates corresponding to the first current pixel, (Ta(i)*)−1 is inverse model transformation of a finally generated current frame of image, that is, target image, and Ta(i−1) is model transformation corresponding to a historical frame of image.

Operation 714. Determine a pixel corresponding to the first historical world coordinates in the historical diffuse reflection image as a first historical pixel, determine an object identifier of the first current pixel, and determine an object identifier of the first historical pixel.

Operation 716. Determine whether a first object identifier is consistent with a second object identifier. If yes, operation 718 is performed; or if no, operation 720 is performed.

The first object identifier refers to the object identifier of the first current pixel, and the second object identifier refers to the object identifier of the first historical pixel.

Operation 718. Determine the first historical pixel as a first reference pixel corresponding to the first current pixel.

Operation 720. Determine world coordinates corresponding to the first historical pixel, to obtain second historical world coordinates, determine world coordinates of a world space point at the second historical world coordinates at the current moment, to obtain second current world coordinates, and offset the first historical world coordinates according to a first coordinate offset between the first current world coordinates and the second current world coordinates, to obtain first target world coordinates.

Operation 722. Determine a pixel corresponding to the first target world coordinates in the historical diffuse reflection image, to obtain a candidate pixel.

Operation 724. Determine the candidate pixel as a first reference pixel corresponding to the first current pixel when the first object identifier is consistent with a candidate object identifier.

The first object identifier refers to the object identifier of the first current pixel, and the candidate object identifier refers to an object identifier of the candidate pixel.

Operation 726. Denoise the corresponding first current pixel in the current diffuse reflection image by using the first reference pixel, to obtain the target diffuse reflection image.

Operation 728. Determine, for each second current pixel, a virtual image point position corresponding to the second current pixel, determine a position at which a target connecting line intersects with a normal plane of the second current pixel to obtain a target intersection point position, and determine a pixel corresponding to the target intersection point position in the historical specular reflection image as a second reference pixel of the second current pixel.

The second current pixel is a pixel in the current specular reflection image. The target connecting line is a connecting line between an observation position at the historical moment and the virtual image point position.

Operation 730. Determine, for each second current pixel, world coordinates of a world space point corresponding to the second current pixel at the historical moment, to obtain third historical world coordinates, and determine a third reference pixel corresponding to the second current pixel based on a pixel corresponding to the third historical world coordinates in the historical specular reflection image.

The second current pixel is a pixel in the current specular reflection image.

Operation 732. Denoise the corresponding second current pixel in the current specular reflection image based on the second reference pixel and the third reference pixel, to obtain a target specular reflection image.

Operation 734. Perform image fusion on the target direct illumination image, the target diffuse reflection image, and the target specular reflection image, to obtain a current video frame.

In this embodiment, the indirect illumination with a higher noise degree continues to be subdivided into diffuse reflection indirect illumination and specular reflection indirect illumination, so that a more specialized denoising solution is separately performed on the two subdivided signals, and a finally synthesized image signal is finer and has better noise quality, thereby implementing a temporal filtering technology with higher denoising quality. The indirect illumination signal is further subdivided into a diffuse reflection indirect illumination signal and a specular reflection indirect illumination signal, and more specialized denoising is performed, thereby achieving a more accurate denoising effect. In addition, more motion vectors (bidirectional motion vectors and specular motion vectors) are provided in the temporal filtering stage, to generate more reference points, reference weights of the reference points are evaluated based on color differences, material differences, and the like of the reference points, and finally, a more accurate temporal mixing effect can be achieved through synthesis, thereby alleviating ghosting. By using the image denoising method provided in this application, denoising quality of an indirect illumination signal of an image can be improved, excessive blurring of a specular reflection signal can be alleviated, and an error of blind mixing can be effectively avoided, thereby reducing ghosting. Therefore, a better result is achieved by computer resources configured for supporting denoising, and waste of the computer resources configured for supporting denoising is reduced.

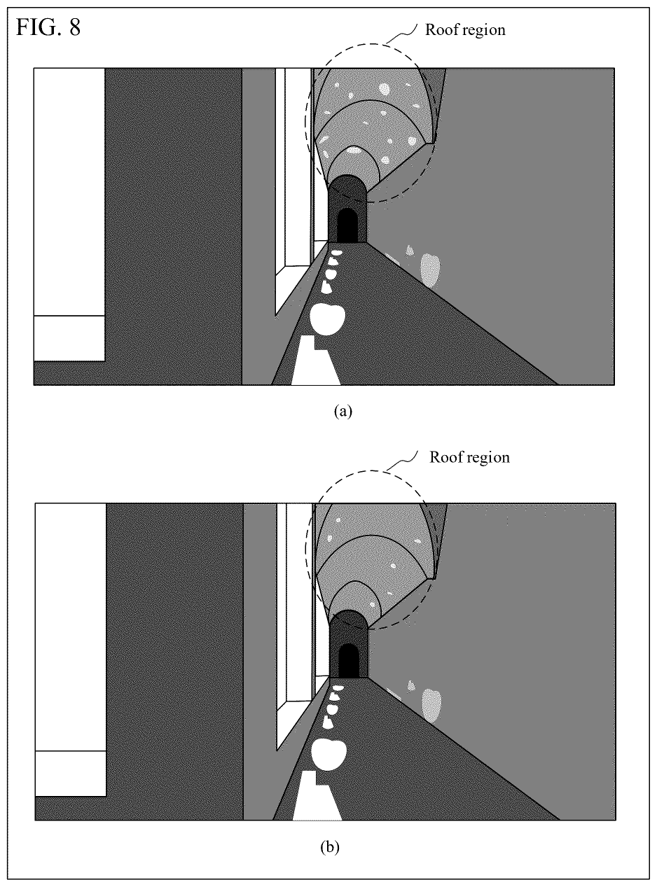

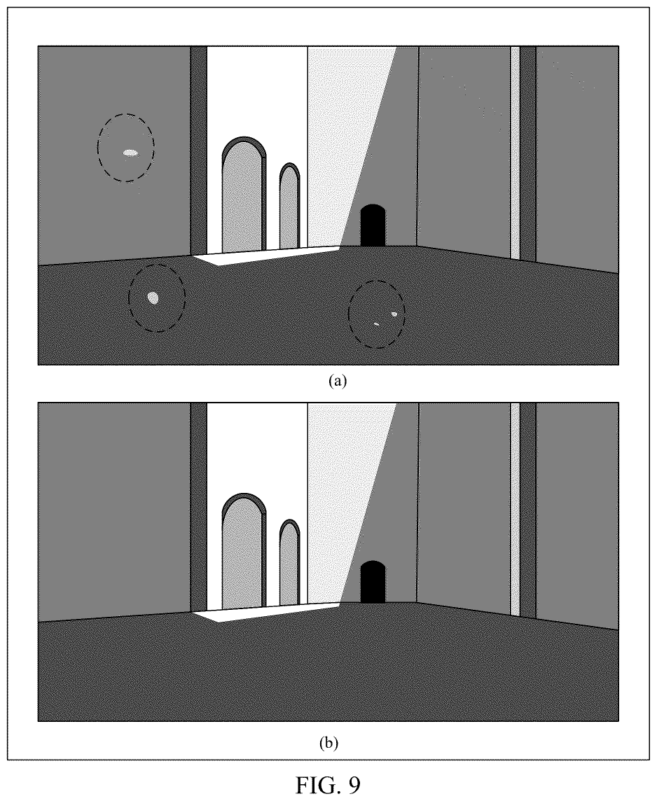

The image denoising method provided in this application may be applied to any scene in which real-time rendering needs to be performed, including but not limited to a game scene, a VR scene, or an animation scene. Using an example in which the image denoising method is applied to a game scene, an image displayed in real time in a game playing process is a result obtained through the image denoising method provided in this application. For example, in a process of generating a current frame of image, the terminal determines a current diffuse reflection image, a current specular reflection image, and a current direct illumination image, acquires a historical diffuse reflection image and a historical specular reflection image that correspond to a historical frame of image, denoises the current diffuse reflection image by using the historical diffuse reflection image, to obtain a target diffuse reflection image, denoises the current specular reflection image by using the historical specular reflection image, to obtain a target specular reflection image, denoises the current direct illumination image to obtain a target direct illumination image, fuses the target diffuse reflection image, the target specular reflection image, and the target direct illumination image, to obtain a current frame of image, and displays the current frame of image. By using the image denoising method provided in this application, a denoising effect can be improved. (a) of FIG. 8 shows an image obtained by performing denoising by using a conventional image denoising method. (b) of FIG. 8 shows an image obtained by performing denoising by using the image denoising method provided in this application. It can be seen that there is more odd illumination in a roof region in (a) of FIG. 8, while a roof region in (b) of FIG. 8 is more realistic. (a) of FIG. 9 shows an image obtained by performing denoising by using a conventional image denoising method. (b) of FIG. 9 shows an image obtained by performing denoising by using the image denoising method provided in this application. It can be seen that there is odd illumination in a region indicated by an oval dashed box in (a) of FIG. 9. Therefore, it can be seen that the image denoising method provided in this application improves a denoising effect.

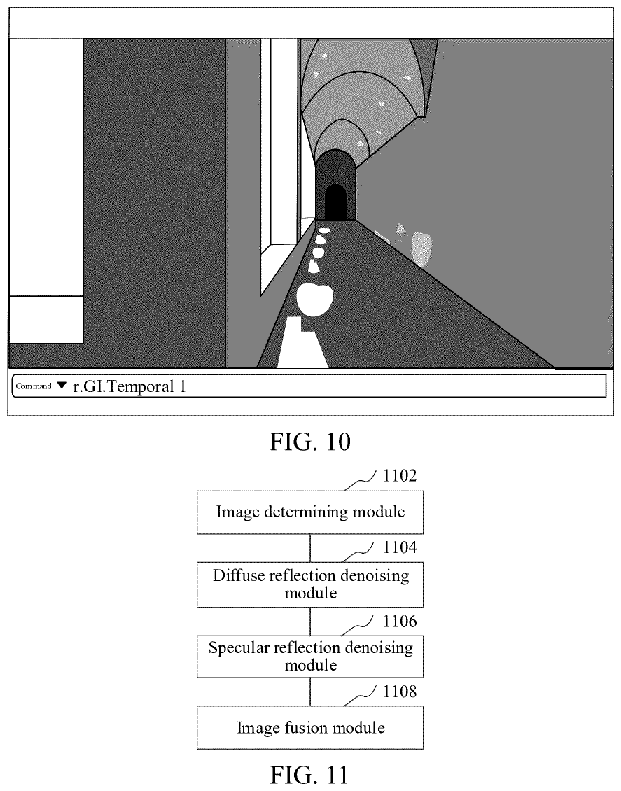

The image denoising method provided in this embodiment may be applied to a game engine, for example, an unreal engine, to render a game picture in real time. FIG. 10 is a diagram of an interface of rendering a game picture in real time in an unreal engine. In actual application, before real-time rendering, for example, after the terminal starts a game, the terminal may display a denoising manner determining region, and perform, in response to a denoising manner determined from the denoising manner determining region, real-time rendering based on the determined denoising manner. Denoising manners may include no denoising, a conventional denoising manner, and an image denoising manner provided in this application. The denoising manner may be determined through selection or a preset instruction. As shown in FIG. 10, the preset instruction is r.GI.Temporal. When the number carried after the preset instruction is 0, it indicates that no denoising is selected. When the number carried after the preset instruction is 1, it indicates that the image denoising manner provided in this application is selected. When the number carried after the preset instruction is 2, it indicates that the conventional denoising manner is selected.

The image denoising method provided in this embodiment may also be applied to a real-time rendering process of a simulation scene. The simulation scene includes but is not limited to a simulation scene of a real driving scene and a simulation scene of a real acting scene. In a process of rendering a simulation scene in real time, to generate a current frame of image in the simulation scene, the terminal may determine a current diffuse reflection image, a current specular reflection image, and a current direct illumination image, acquires a historical diffuse reflection image and a historical specular reflection image that correspond to a historical frame of image, denoises the current diffuse reflection image by using the historical diffuse reflection image, to obtain a target diffuse reflection image, denoises the current specular reflection image by using the historical specular reflection image, to obtain a target specular reflection image, denoises the current direct illumination image to obtain a target direct illumination image, fuses the target diffuse reflection image, the target specular reflection image, and the target direct illumination image, to obtain a current frame of image, and displays the current frame of image. By using the image denoising method provided in this application, a denoising effect on an image in a simulation scene can be improved.

Although the operations in the flowcharts involved in the foregoing embodiments are sequentially shown according to indication of an arrow, the operations are not necessarily sequentially performed according to a sequence indicated by the arrow. Unless explicitly specified in this application, execution of the operations is not strictly limited, and the operations may be performed in other sequences. Moreover, at least some of the operations in the flowcharts involved in the foregoing embodiments may include a plurality of operations or a plurality of stages. The operations or stages are not necessarily performed at the same moment but may be performed at different moments. Execution of the operations or stages is not necessarily sequentially performed, but may be performed alternately with other operations or at least some of operations or stages of other operations.

Based on the same inventive concept, an embodiment of this application further provides an image denoising apparatus for implementing the foregoing involved image denoising method. An implementation solution for resolving the problem provided by the apparatus is similar to the implementation solution described in the foregoing method. Therefore, for specific limitations in one or more embodiments of the image denoising apparatus provided below, reference may be made to the foregoing limitations on the image denoising method, and details are not described herein again.

In some embodiments, as shown in FIG. 11, an image denoising apparatus is provided, including: an image determining module 1102, a diffuse reflection denoising module 1104, a specular reflection denoising module 1106, and an image fusion module 1108.

The image determining module 1102 is configured to acquire a current diffuse reflection image and a current specular reflection image, the current diffuse reflection image being an image obtained by performing illumination rendering on a scene region observed at a current moment by using diffuse reflection illumination, and the current specular reflection image being an image obtained by performing illumination rendering on the scene region observed at the current moment by using specular reflection illumination.

The image determining module 1102 is further configured to acquire a historical diffuse reflection image, the historical diffuse reflection image being an image obtained by performing illumination rendering on a scene region observed at a historical moment by using diffuse reflection illumination.

The diffuse reflection denoising module 1104 is configured to denoise the current diffuse reflection image by using the historical diffuse reflection image, to obtain a target diffuse reflection image.

The image determining module 1102 is further configured to acquire a historical specular reflection image, the historical specular reflection image being an image obtained by performing illumination rendering on the scene region observed at the historical moment by using specular reflection illumination.

The specular reflection denoising module 1106 is configured to denoise the current specular reflection image by using the historical specular reflection image, to obtain a target specular reflection image.

The image fusion module 1108 is configured to perform image fusion on the target diffuse reflection image and the target specular reflection image, to obtain a target image.

In some embodiments, pixels in the current diffuse reflection image are first current pixels, and the diffuse reflection denoising module 1104 is further configured to map each of the first current pixels from a screen space to a world space, to obtain a world space point corresponding to each of the first current pixels; acquire, for each of the first current pixels, coordinates of the world space point corresponding to the first current pixel at the historical moment in the world space, to obtain first historical world coordinates; map each of the first historical world coordinates from the world space to the screen space, to obtain screen space coordinates corresponding to each of the first historical world coordinates; determine, for each of the first current pixels, a first reference pixel corresponding to the first current pixel based on a pixel at screen space coordinates corresponding to the first historical world coordinates in the historical diffuse reflection image; and denoise the corresponding first current pixel in the current diffuse reflection image by using the first reference pixel, to obtain the target diffuse reflection image.

In some embodiments, the diffuse reflection denoising module 1104 is further configured to use a pixel at the screen space coordinates corresponding to the first historical world coordinates in the historical diffuse reflection image as a first historical pixel; acquire an object identifier of the first current pixel and an object identifier of the first historical pixel; and determine the first historical pixel as the first reference pixel corresponding to the first current pixel when the object identifier of the first current pixel is consistent with the object identifier of the first historical pixel.

In some embodiments, the diffuse reflection denoising module 1104 is further configured to map coordinates of the first current pixel in the screen space to coordinates in the world space, to obtain first current world coordinates; map coordinates of the first historical pixel in the screen space to coordinates in the world space when the object identifier of the first current pixel is inconsistent with the object identifier corresponding to the first historical pixel, to obtain second historical world coordinates; acquire world coordinates of a world space point at the second historical world coordinates at the current moment, to obtain second current world coordinates; determine an offset between the first current world coordinates and the second current world coordinates, to obtain a first coordinate offset; offset the first historical world coordinates based on the first coordinate offset, to obtain first target world coordinates; map the first target world coordinates from the world space to coordinates in the screen space, to obtain screen space coordinates corresponding to the first target world coordinates; and determine a pixel at the screen space coordinates corresponding to the first target world coordinates in the historical diffuse reflection image as the first reference pixel corresponding to the first current pixel.

In some embodiments, the diffuse reflection denoising module 1104 is further configured to use the pixel at the screen space coordinates corresponding to the first target world coordinates in the historical diffuse reflection image as a candidate pixel; acquire an object identifier of the candidate pixel; and determine the candidate pixel as the first reference pixel corresponding to the first current pixel when the object identifier of the first current pixel is consistent with the object identifier of the candidate pixel.

In some embodiments, the diffuse reflection denoising module 1104 is further configured to acquire, for each of the first current pixels, an attribute similarity between the first current pixel and the corresponding first reference pixel; determine a weight of the first reference pixel corresponding to the first current pixel based on the attribute similarity; fuse, for each of the first current pixels, a pixel value of the first current pixel and a pixel value of the corresponding first reference pixel by using the weight of the first reference pixel corresponding to the first current pixel, to obtain a fused pixel value of the first current pixel; and obtain the target diffuse reflection image based on fused pixel values respectively corresponding to the first current pixels in the current diffuse reflection image.

In some embodiments, pixels in the current specular reflection image are second current pixels, and the specular reflection denoising module 1106 is further configured to map, for each second current pixel, coordinates of the second current pixel in the screen space to the world space, to obtain a target space position; acquire an incident light transmission distance corresponding to the target space position, the incident light transmission distance being a transmission distance of a target incident light ray at the target space position, the target incident light ray being reflected at the target space position, and a reflected light ray being observed at the current moment; determine a position offset based on an observation direction at the current moment and the incident light transmission distance; offset the target space position by using the position offset, to obtain a virtual image point position corresponding to the second current pixel; and denoise the current specular reflection image based on the virtual image point position and the historical specular reflection image, to obtain the target specular reflection image.

In some embodiments, the specular reflection denoising module 1106 is further configured to determine a connecting line between an observation position at the historical moment and the virtual image point position, to obtain a target connecting line; determine a position at which the target connecting line intersects with a normal plane of the second current pixel, to obtain a target intersection point position; map the target intersection point position from the world space to the screen space, to obtain screen space coordinates corresponding to the target intersection point position; determine a pixel at the screen space coordinates corresponding to the target intersection point position in the historical specular reflection image as a second reference pixel of the second current pixel; and denoise the corresponding second current pixel in the current specular reflection image by using the second reference pixel, to obtain the target specular reflection image.

In some embodiments, pixels in the current specular reflection image are second current pixels, and the specular reflection denoising module 1106 is further configured to map each of the second current pixels from a screen space to a world space, to obtain a world space point corresponding to each of the second current pixels; acquire, for each of the second current pixels, coordinates of the world space point corresponding to the second current pixel at the historical moment in the world space, to obtain third historical world coordinates; map each of the third historical world coordinates from the world space to coordinates in the screen space, to obtain screen space coordinates corresponding to each of the third historical world coordinates; determine, for each of the second current pixels, a third reference pixel corresponding to the second current pixel based on a pixel at screen space coordinates corresponding to the third historical world coordinates in the historical specular reflection image; and denoise the corresponding second current pixel in the current specular reflection image based on the third reference pixel, to obtain the target specular reflection image.

In some embodiments, the specular reflection denoising module 1106 is further configured to determine a pixel at the screen space coordinates corresponding to the third historical world coordinates in the historical specular reflection image as a second historical pixel; acquire an object identifier of the second current pixel and an object identifier of the second historical pixel; and determine the second historical pixel as the third reference pixel corresponding to the second current pixel when the object identifier of the second current pixel is consistent with the object identifier of the second historical pixel.

In some embodiments, the specular reflection denoising module 1106 is further configured to map coordinates of the second current pixel in the screen space to coordinates in the world space, to obtain third current world coordinates; map coordinates of the second historical pixel in the screen space to coordinates in the world space when the object identifier of the second current pixel is inconsistent with the object identifier of the second historical pixel, to obtain fourth historical world coordinates; acquire world coordinates of a world space point at the fourth historical world coordinates at the current moment, to obtain fourth current world coordinates; use an offset between the third current world coordinates and the fourth current world coordinates as a second coordinate offset; offset the third historical world coordinates based on the second coordinate offset, to obtain second target world coordinates; map the second target world coordinates from the world space to coordinates in the screen space, to obtain screen space coordinates corresponding to the second target world coordinates; and determine a pixel at the screen space coordinates corresponding to the second target world coordinates in the historical specular reflection image as the third reference pixel corresponding to the second current pixel.

In some embodiments, the image fusion module 1108 is further configured to acquire a current direct illumination image; the current direct illumination image being an image obtained by performing illumination rendering on the scene region observed at the current moment by using direct illumination; denoise the current direct illumination image to obtain a target direct illumination image; and perform image fusion on the target diffuse reflection image, the target specular reflection image, and the target direct illumination image to obtain the target image.

The modules in the foregoing image denoising apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

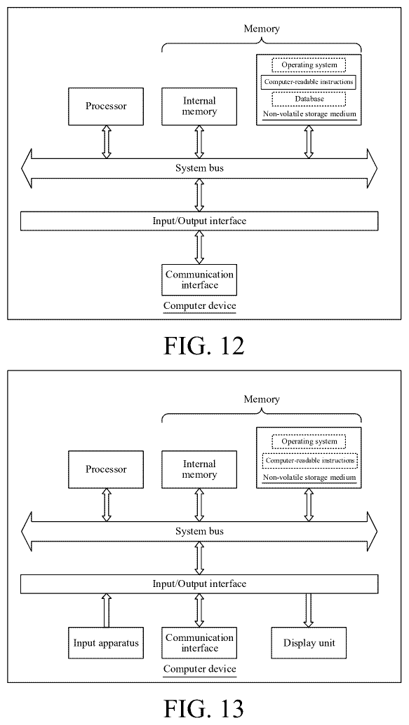

In some embodiments, a computer device is provided. The computer device may be a server, and an internal structure diagram thereof may be shown in FIG. 12. The computer device includes a processor, a memory, an Input/Output (I/O) interface, and a communications interface. The processor, the memory, and the input/output interface are connected by using a system bus, and the communication interface is connected to the system bus by using the input/output interface. The processor of the computer device is configured to provide computing and control capabilities. The memory of the computer device includes a non-volatile storage medium and an internal memory. The non-volatile storage medium stores an operating system, computer-readable instructions, and a database. The internal memory provides an environment for running of the operating system and the computer-readable instructions in the non-volatile storage medium. The database of the computer device is configured to store data involved in the image denoising method. The input/output interface of the computer device is configured to exchange information between the processor and an external device. The communication interface of the computer device is configured to communicate with an external terminal through a network connection. The computer-readable instructions are executed by the processor to implement an image denoising method.

In some embodiments, a computer device is provided. The computer device may be a terminal, and an internal structure diagram thereof may be shown in FIG. 13. The computer device includes a processor, a memory, an input/output interface, a communication interface, a display unit, and an input apparatus. The processor, the memory, and the input/output interface are connected by using a system bus, and the communication interface, the display unit, and the input apparatus are connected to the system bus by using the input/output interface. The processor of the computer device is configured to provide computing and control capabilities. The memory of the computer device includes a non-volatile storage medium and an internal memory. The non-volatile storage medium stores an operating system and computer-readable instructions. The internal memory provides an environment for running of the operating system and the computer-readable instructions in the non-volatile storage medium. The input/output interface of the computer device is configured to exchange information between the processor and an external device. The communication interface of the computer device is configured to communicate with an external terminal in a wired or wireless manner. The wireless manner may be implemented by using Wi-Fi, a mobile cellular network, near field communication (NFC), or another technology. The computer-readable instructions are executed by the processor to implement an image denoising method. The display unit of the computer device is configured to form a visually visible picture, and may be a display screen, a projection apparatus, or a VR imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, a mouse or the like.

A person skilled in the art may understand that, the structures shown in FIG. 12 and FIG. 13 are merely block diagrams of partial structures related to a solution in this application, and do not constitute a limitation to the computer device to which the solution in this application is applied. Specifically, the computer device may include more or fewer components than those shown in the figure, or have some components combined, or have a different component deployment.

In some embodiments, a computer device is provided, including a memory and one or more processors, the memory storing computer-readable instructions, the processor, when executing the computer-readable instructions, implementing the foregoing image denoising method.

In some embodiments, one or more readable storage media are provided, having computer-readable instructions stored therein. The computer-readable instructions are executed by a processor to implement the foregoing image denoising method.

In some embodiments, a computer program product is provided, including computer-readable instructions. The computer-readable instructions are executed by one or more processors to implement the foregoing image denoising method.

User information (including but not limited to user equipment information, user personal information, and the like) and data (including but not limited to data for analysis, stored data, displayed data, and the like) involved in this application are all authorized by users or fully authorized by all parties, and collection, use, and processing of relevant data need to comply with relevant laws, regulations, and standards of relevant countries and regions.

A person of ordinary skill in the art may understand that some or all procedures in the method in the foregoing embodiments may be implemented by a computer-readable instruction instructing related hardware, the computer-readable instructions may be stored in a non-volatile computer readable storage medium, and when the computer-readable instructions are executed, the procedures in the foregoing method embodiments may be implemented. Any reference to a memory, a database, or another medium used in the various embodiments provided herein can include at least one of a non-volatile and a volatile memory. The non-volatile memory may include a Read-Only Memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. For the purpose of description instead of limitation, the RAM is available in a plurality of forms, such as a static RAM (SRAM) or a dynamic RAM (DRAM). The database involved in the embodiments provided in this application may include at least one of a relational database and a non-relational database. The non-relational database may include, but is not limited to, a blockchain-based distributed database, or the like. The processor involved in the embodiments provided in this application may be a general-purpose processor, a central processing unit, a graphics processing unit, a digital signal processor, a programmable logic device, a data processing logic device based on quantum computing, or the like, but is not limited thereto.

The technical features in the foregoing embodiments may be randomly combined. For concise description, not all possible combinations of the technical features in the embodiment are described. However, the combinations of the technical features are all to be considered as falling within the scope described in this specification provided that they do not conflict with each other.

The foregoing embodiments only show several implementations of this application and are described in detail, but they are not to be construed as a limit to the patent scope of this application. A person of ordinary skill in the art may further make variations and improvements without departing from the ideas of this application, which shall fall within the protection scope of this application. Therefore, the protection scope of this application shall be subject to the appended claims.

What is claimed is:

1. An image denoising method, performed by a computer device, the method comprising:
acquiring a current diffuse reflection image and a current specular reflection image, the current diffuse reflection image being an image obtained by performing diffuse reflection illumination on a scene region observed at a current moment, and the current specular reflection image being an image obtained by performing specular reflection illumination on the scene region observed at the current moment;
acquiring a historical diffuse reflection image, the historical diffuse reflection image being an image obtained by performing diffuse reflection illumination on a scene region observed at a historical moment;
denoising the current diffuse reflection image using the historical diffuse reflection image, to obtain a target diffuse reflection image;
acquiring a historical specular reflection image, the historical specular reflection image being an image obtained by performing specular reflection illumination on the scene region observed at the historical moment;
denoising the current specular reflection image using the historical specular reflection image, to obtain a target specular reflection image; and
fusing the target diffuse reflection image and the target specular reflection image, to obtain a target image.

2. The method according to claim 1, wherein pixels in the current diffuse reflection image are first current pixels, and the denoising the current diffuse reflection image using the historical diffuse reflection image, to obtain a target diffuse reflection image comprises:
mapping each of the first current pixels from a screen space to a world space, to obtain a world space point corresponding to each of the first current pixels;
acquiring, for each of the first current pixels, coordinates of the world space point corresponding to the first current pixel at the historical moment in the world space, to obtain first historical world coordinates;
mapping each of the first historical world coordinates from the world space to the screen space, to obtain screen space coordinates corresponding to each of the first historical world coordinates;
determining, for each of the first current pixels, a first reference pixel corresponding to the first current pixel based on a pixel at screen space coordinates corresponding to the first historical world coordinates in the historical diffuse reflection image; and
denoising the corresponding first current pixel in the current diffuse reflection image using the first reference pixel, to obtain the target diffuse reflection image.

3. The method according to claim 2, wherein the determining a first reference pixel corresponding to the first current pixel based on a pixel at screen space coordinates corresponding to the first historical world coordinates in the historical diffuse reflection image comprises:
using a pixel at the screen space coordinates corresponding to the first historical world coordinates in the historical diffuse reflection image as a first historical pixel;
acquiring an object identifier of the first current pixel and an object identifier of the first historical pixel; and
determining the first historical pixel as the first reference pixel corresponding to the first current pixel when the object identifier of the first current pixel is consistent with the object identifier of the first historical pixel.

4. The method according to claim 3, wherein the method further comprises:
mapping coordinates of the first current pixel in the screen space to coordinates in the world space, to obtain first current world coordinates;
mapping coordinates of the first historical pixel in the screen space to coordinates in the world space when the object identifier of the first current pixel is inconsistent with the object identifier corresponding to the first historical pixel, to obtain second historical world coordinates;
acquiring world coordinates of a world space point at the second historical world coordinates at the current moment, to obtain second current world coordinates;
determining an offset between the first current world coordinates and the second current world coordinates, to obtain a first coordinate offset;
offsetting the first historical world coordinates based on the first coordinate offset, to obtain first target world coordinates;
mapping the first target world coordinates from the world space to coordinates in the screen space, to obtain screen space coordinates corresponding to the first target world coordinates; and
determining a pixel at the screen space coordinates corresponding to the first target world coordinates in the historical diffuse reflection image as the first reference pixel corresponding to the first current pixel.

5. The method according to claim 4, wherein the determining a pixel at the screen space coordinates corresponding to the first target world coordinates in the historical diffuse reflection image as the first reference pixel corresponding to the first current pixel comprises:
using the pixel at the screen space coordinates corresponding to the first target world coordinates in the historical diffuse reflection image as a candidate pixel;
acquiring an object identifier of the candidate pixel; and
determining the candidate pixel as the first reference pixel corresponding to the first current pixel when the object identifier of the first current pixel is consistent with the object identifier of the candidate pixel.

6. The method according to claim 2, wherein the denoising the corresponding first current pixel in the current diffuse reflection image using the first reference pixel, to obtain the target diffuse reflection image comprises:
acquiring, for each of the first current pixels, an attribute similarity between the first current pixel and the corresponding first reference pixel;
determining a weight of the first reference pixel corresponding to the first current pixel based on the attribute similarity;
fusing, for each of the first current pixels, a pixel value of the first current pixel and a pixel value of the corresponding first reference pixel using the weight of the first reference pixel corresponding to the first current pixel, to obtain a fused pixel value of the first current pixel; and
obtaining the target diffuse reflection image based on fused pixel values respectively corresponding to the first current pixels in the current diffuse reflection image.

7. The method according to claim 1, wherein pixels in the current specular reflection image are second current pixels, and the denoising the current specular reflection image using the historical specular reflection image, to obtain a target specular reflection image comprises:
mapping, for each second current pixel, coordinates of the second current pixel in the screen space to the world space, to obtain a target space position;
acquiring an incident light transmission distance corresponding to the target space position, the incident light transmission distance being a transmission distance of a target incident light ray at the target space position, the target incident light ray being reflected at the target space position, and a reflected light ray being observed at the current moment;
determining a position offset based on an observation direction at the current moment and the incident light transmission distance;
offsetting the target space position using the position offset, to obtain a virtual image point position corresponding to the second current pixel; and
denoising the current specular reflection image based on the virtual image point position and the historical specular reflection image, to obtain the target specular reflection image.

8. The method according to claim 7, wherein the denoising the current specular reflection image based on the virtual image point position and the historical specular reflection image, to obtain the target specular reflection image comprises:
determining a connecting line between an observation position at the historical moment and the virtual image point position, to obtain a target connecting line;
determining a position at which the target connecting line intersects with a normal plane of the second current pixel, to obtain a target intersection point position;
mapping the target intersection point position from the world space to the screen space, to obtain screen space coordinates corresponding to the target intersection point position;
determining a pixel at the screen space coordinates corresponding to the target intersection point position in the historical specular reflection image as a second reference pixel of the second current pixel; and
denoising the corresponding second current pixel in the current specular reflection image using the second reference pixel, to obtain the target specular reflection image.

9. The method according to claim 1, wherein pixels in the current specular reflection image are second current pixels, and the denoising the current specular reflection image using the historical specular reflection image, to obtain a target specular reflection image comprises:
mapping each of the second current pixels from a screen space to a world space, to obtain a world space point corresponding to each of the second current pixels;
acquiring, for each of the second current pixels, coordinates of the world space point corresponding to the second current pixel at the historical moment in the world space, to obtain third historical world coordinates; mapping each of the third historical world coordinates from the world space to coordinates in the screen space, to obtain screen space coordinates corresponding to each of the third historical world coordinates;
determining, for each of the second current pixels, a third reference pixel corresponding to the second current pixel based on a pixel at screen space coordinates corresponding to the third historical world coordinates in the historical specular reflection image; and
denoising the corresponding second current pixel in the current specular reflection image based on the third reference pixel, to obtain the target specular reflection image.

10. The method according to claim 9, wherein the determining a third reference pixel corresponding to the second current pixel based on a pixel at screen space coordinates corresponding to the third historical world coordinates in the historical specular reflection image comprises:
determining a pixel at the screen space coordinates corresponding to the third historical world coordinates in the historical specular reflection image as a second historical pixel;
acquiring an object identifier of the second current pixel and an object identifier of the second historical pixel; and
determining the second historical pixel as the third reference pixel corresponding to the second current pixel when the object identifier of the second current pixel is consistent with the object identifier of the second historical pixel.

11. The method according to claim 10, wherein the method further comprises:
mapping coordinates of the second current pixel in the screen space to coordinates in the world space, to obtain third current world coordinates;
mapping coordinates of the second historical pixel in the screen space to coordinates in the world space when the object identifier of the second current pixel is inconsistent with the object identifier of the second historical pixel, to obtain fourth historical world coordinates;
acquiring world coordinates of a world space point at the fourth historical world coordinates at the current moment, to obtain fourth current world coordinates;
using an offset between the third current world coordinates and the fourth current world coordinates as a second coordinate offset;
offsetting the third historical world coordinates based on the second coordinate offset, to obtain second target world coordinates;
mapping the second target world coordinates from the world space to coordinates in the screen space, to obtain screen space coordinates corresponding to the second target world coordinates; and
determining a pixel at the screen space coordinates corresponding to the second target world coordinates in the historical specular reflection image as the third reference pixel corresponding to the second current pixel.

12. The method according to claim 1, wherein fusing the target diffuse reflection image and the target specular reflection image, to obtain a target image, comprises:
acquiring a current direct illumination image by performing illumination rendering on the scene region observed at the current moment using direct illumination;
denoising the current direct illumination image to obtain a target direct illumination image; and
performing image fusion on the target diffuse reflection image, the target specular reflection image, and the target direct illumination image to obtain the target image.

13. One or more non-transitory computer readable media comprising computer readable instructions which, when executed by a processor, configure a data processing system to denoise an image by:
acquiring a current diffuse reflection image and a current specular reflection image, the current diffuse reflection image being an image obtained by performing diffuse reflection illumination on a scene region observed at a current moment, and the current specular reflection image being an image obtained by performing specular reflection illumination on the scene region observed at the current moment;
acquiring a historical diffuse reflection image, the historical diffuse reflection image being an image obtained by performing diffuse reflection illumination on a scene region observed at a historical moment;
denoising the current diffuse reflection image using the historical diffuse reflection image, to obtain a target diffuse reflection image;
acquiring a historical specular reflection image, the historical specular reflection image being an image obtained by performing specular reflection illumination on the scene region observed at the historical moment;
denoising the current specular reflection image using the historical specular reflection image, to obtain a target specular reflection image; and
fusing the target diffuse reflection image and the target specular reflection image, to obtain a target image.

14. The computer readable media according to claim 13, wherein pixels in the current diffuse reflection image are first current pixels, and the denoising the current diffuse reflection image using the historical diffuse reflection image, to obtain a target diffuse reflection image comprises:
mapping each of the first current pixels from a screen space to a world space, to obtain a world space point corresponding to each of the first current pixels;
acquiring, for each of the first current pixels, coordinates of the world space point corresponding to the first current pixel at the historical moment in the world space, to obtain first historical world coordinates;
mapping each of the first historical world coordinates from the world space to the screen space, to obtain screen space coordinates corresponding to each of the first historical world coordinates;
determining, for each of the first current pixels, a first reference pixel corresponding to the first current pixel based on a pixel at screen space coordinates corresponding to the first historical world coordinates in the historical diffuse reflection image; and
denoising the corresponding first current pixel in the current diffuse reflection image using the first reference pixel, to obtain the target diffuse reflection image.

15. The computer readable media according to claim 14, wherein the determining a first reference pixel corresponding to the first current pixel based on a pixel at screen space coordinates corresponding to the first historical world coordinates in the historical diffuse reflection image comprises:
using a pixel at the screen space coordinates corresponding to the first historical world coordinates in the historical diffuse reflection image as a first historical pixel;
acquiring an object identifier of the first current pixel and an object identifier of the first historical pixel; and
determining the first historical pixel as the first reference pixel corresponding to the first current pixel when the object identifier of the first current pixel is consistent with the object identifier of the first historical pixel.

16. The computer readable media according to claim 13, wherein pixels in the current specular reflection image are second current pixels, and the denoising the current specular reflection image using the historical specular reflection image, to obtain a target specular reflection image comprises:
mapping, for each second current pixel, coordinates of the second current pixel in the screen space to the world space, to obtain a target space position;
acquiring an incident light transmission distance corresponding to the target space position, the incident light transmission distance being a transmission distance of a target incident light ray at the target space position, the target incident light ray being reflected at the target space position, and a reflected light ray being observed at the current moment;
determining a position offset based on an observation direction at the current moment and the incident light transmission distance;
offsetting the target space position using the position offset, to obtain a virtual image point position corresponding to the second current pixel; and
denoising the current specular reflection image based on the virtual image point position and the historical specular reflection image, to obtain the target specular reflection image.

17. The computer readable media according to claim 16, wherein the denoising the current specular reflection image based on the virtual image point position and the historical specular reflection image, to obtain the target specular reflection image comprises:
determining a connecting line between an observation position at the historical moment and the virtual image point position, to obtain a target connecting line;
determining a position at which the target connecting line intersects with a normal plane of the second current pixel, to obtain a target intersection point position;
mapping the target intersection point position from the world space to the screen space, to obtain screen space coordinates corresponding to the target intersection point position;
determining a pixel at the screen space coordinates corresponding to the target intersection point position in the historical specular reflection image as a second reference pixel of the second current pixel; and
denoising the corresponding second current pixel in the current specular reflection image using the second reference pixel, to obtain the target specular reflection image.

18. The computer readable media according to claim 13, wherein pixels in the current specular reflection image are second current pixels, and the denoising the current specular reflection image using the historical specular reflection image, to obtain a target specular reflection image comprises:
mapping each of the second current pixels from a screen space to a world space, to obtain a world space point corresponding to each of the second current pixels;
acquiring, for each of the second current pixels, coordinates of the world space point corresponding to the second current pixel at the historical moment in the world space, to obtain third historical world coordinates; mapping each of the third historical world coordinates from the world space to coordinates in the screen space, to obtain screen space coordinates corresponding to each of the third historical world coordinates;
determining, for each of the second current pixels, a third reference pixel corresponding to the second current pixel based on a pixel at screen space coordinates corresponding to the third historical world coordinates in the historical specular reflection image; and
denoising the corresponding second current pixel in the current specular reflection image based on the third reference pixel, to obtain the target specular reflection image.

19. The computer readable media according to claim 13, wherein fusing the target diffuse reflection image and the target specular reflection image, to obtain a target image, comprises:
acquiring a current direct illumination image by performing illumination rendering on the scene region observed at the current moment using direct illumination;
denoising the current direct illumination image to obtain a target direct illumination image; and
performing image fusion on the target diffuse reflection image, the target specular reflection image, and the target direct illumination image to obtain the target image.

20. A data processing system comprising:
a processor; and
memory storing computer readable instructions which, when executed by the processor, configure the data processing system to denoise an image by:
acquiring a current diffuse reflection image and a current specular reflection image, the current diffuse reflection image being an image obtained by performing diffuse reflection illumination on a scene region observed at a current moment, and the current specular reflection image being an image obtained by performing specular reflection illumination on the scene region observed at the current moment;
acquiring a historical diffuse reflection image, the historical diffuse reflection image being an image obtained by performing diffuse reflection illumination on a scene region observed at a historical moment;
denoising the current diffuse reflection image using the historical diffuse reflection image, to obtain a target diffuse reflection image;
acquiring a historical specular reflection image, the historical specular reflection image being an image obtained by performing specular reflection illumination on the scene region observed at the historical moment;
denoising the current specular reflection image using the historical specular reflection image, to obtain a target specular reflection image; and
fusing the target diffuse reflection image and the target specular reflection image, to obtain a target image.
